(19) United States
(12) Patent Application Publication
(10) Pub. No.: US 2008/0294450 A1
(43) Pub. Date: Nov. 27, 2008

(54) MARKETING SUPPORT PROCESSING METHOD, SYSTEM AND PROGRAM

(75) Inventors: Tomomi KASAHARA, Kawasaki (JP); Satsuki OSHIMA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/046,052

(22) Filed: Mar. 11, 2008

(30) Foreign Application Priority Data
May 23, 2007 (JP) JP2007-136100

(51) Int. Cl. G06Q 99/00

(52) U.S. Cl. 705/1

(57) ABSTRACT

A marketing support executed by a computer upon receipt of a map display request from a shop terminal, specifies a map element corresponding to a shop Based on identification information for the specified map element, a blog management database storing blog user identification information for each blog and identification information of a map element registered in a map in the blog is referred and/or a map element database storing information on a shop corresponding to the map element and identification information of a registerer blog including the map element is referred. For example, registered address information of a blog user of each registerer blog is extracted from a user master database storing the registered address information of the blog user, and shop-aimed map data having arranged therein a mark indicating each of the registerer blogs in accordance with the extracted registered address information is generated.

### CROSS-REFERENCE TO RELATED APPLICATIONS

This application is related to and claims priority to Japanese patent application no. 2007-136100 filed on May 23, 2007 in the Japan Patent Office, and incorporated by reference herein.

### BACKGROUND

### 1. Field

The inventive embodiments relate to a marketing support processing technique utilizing a blog service system.

### SUMMARY

According to an aspect of an embodiment, there is provided a marketing support processing method that is executed by a server capable of accessing a user master database storing registered address information of a blog user, a blog management database storing information identifying a blog user of each blog and information identifying a map element registered in a map in the blog, and a map element database storing information on a shop corresponding to each map element and information identifying a registerer blog containing same map element as a map element registered in the map of the blog The method includes, upon receipt of a map display request from a shop terminal, specifying a map element corresponding to the shop, specifying a registerer blog corresponding to the map element by referring to the blog management database or the map element database, based on the specified map element, extracting, from the user master database, registered address information of a blog user of each specified registerer blog and storing the extracted registered address information of the blog user in a storage unit in correspondence with the information for identifying the registerer blog, and generating shop-aimed map data having arranged therein a mark indicating each registerer blog in accordance with the registered address information of the blog user stored in the storage unit, and transmitting the generated map data to the shop terminal.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a diagram showing a general system configuration according to an embodiment of the invention;

FIG. 2 is a diagram showing an example of a blog user table stored in a user master DB;

FIG. 3 is a diagram showing an example of a shop table stored in the user master DB;

FIG. 4 is a diagram showing an example of a blog management table stored in a blog management DB;

FIG. 5 is a diagram showing an example of data stored in a map DB;

FIG. 6 is a diagram showing an example of data stored in a map element DB;

FIG. 7 is a flowchart showing a processing flow for blog user registration;

FIG. 8 is a view showing an example of a blog user usage registration screen;

FIG. 9 is a view showing an example of a registration completion screen;

FIG. 10 is a flowchart showing a processing flow for service subscription by a shop;

FIG. 11 is a view showing an example of a shop-aimed service usage registration screen;

FIG. 12 is a view showing an example of a shop data input screen;

FIG. 13 is a flowchart showing a processing flow for registration of a favorite shop in the blog;

FIG. 14 is a view showing an example of a registration confirmation screen;

FIG. 15 is a flowchart showing a processing flow for registration of shop moving or shop closing information;

FIG. 16 is a view showing an example of a shop moving/closing registration screen;

FIG. 17 is a flowchart showing a processing flow upon receipt of a map display request;

FIG. 18A is a flowchart showing a processing flow (first part) of a blog user-aimed map generating process;

FIG. 18B is a flowchart showing the processing flow (second part) of the blog user-aimed map generating process;

FIG. 18C is a flowchart showing the processing flow (third part) of the blog user-aimed map generating process;

FIG. 19 is a diagram showing an example of data stored in a work table;

FIG. 20 is a view showing an example of a map (blog user-aimed map) display screen;

FIG. 21 is a view showing an example of the map (blog user-aimed map) display screen;

FIG. 22A is a flowchart showing a processing flow (first part) of a shop-aimed map generating process;

FIG. 22B is a flowchart showing the processing flow (second part) of the shop-aimed map generating process;

FIG. 23 is a diagram showing an example of the data stored in the work table;

FIG. 24 is a view showing an example of a map (shop-aimed map) display screen;

FIG. 25 is a flowchart showing a processing flow of a manager-aimed map generating process;

FIG. 26 is a diagram showing an example of the data stored in the work table;

FIG. 27 is a view showing an example of a map (manager-aimed map) display screen; and

FIG. 28 is a diagram showing the function blocks of a computer.

### DETAILED DESCRIPTION OF THE PREFERRED EMBODIMENTS

A service has come to be available in which a blog user registers his/her favorite shops one by one to generate a map of favorite shops exclusive to him/her on the blog. In the conventional service of this type, however, the same map is displayed by the access of users other than the blog user. Therefore, a shop registered, though probably capable of confirming the blog having the very shop registered therein, cannot grasp attribute information (such as a sex, an age or an address) of the blog users of the particular blog. From the viewpoint of a shop, the attribute information, if acquired, of the blog users of the blog with the shop registered therein can be effectively utilized for marketing. In the case where an area is found where many blog users of a blog having registered therein a given shop are living, for example, the particular shop can more effectively form the marketing strategy for special sales, for example, in the particular area.

Japanese Patent Application Laid-Open No. 2002-83116, for example, discloses a method of collecting customer information using a network. Specifically, a CD-RW having recorded therein information for accessing the network, product information and customer information is handed to each customer at the time of product purchase, so that when the customer accesses the network using the CD-RW, a marketing server collects the product information and the customer information. These pieces of information are stored in a DB, and at the request of the distributor, a customer address map with the products classified by category and distributor is transmitted to the distributor. According to the technique described in this patent publication, the customer information may be collected, but all the customers that have purchased the product do not necessarily access the network using the CD-RW. Also, in order to collect the customer information, a job is required on the part of a shop attendant, etc. to attach a CD-RW to a product or write the customer information in the CD-RW. The same patent publication has no description of a blog service system.

As described above, according to the conventional technique, a shop cannot grasp attribute information of blog users of a blog having registered therein the shop even if the blog users register the shop on their blog. In other words, the attribute information of the blog users cannot be effectively utilized for marketing.

To cope with this problem, according to a marketing support processing method according to an embodiment of the invention described below, a shop can easily grasp a distribution of addresses and attribute information such as a sex and age of blog users of a blog in which the shop is registered. Therefore, a shop can acquire marketing information effective for determining a place where the shop moves or opens a branch shop. Also, the shop can grasp the addresses of the blog users registered in the blog closely watched by a multiplicity of persons, and therefore, can conduct the sales promotion campaign in and around the particular place, or by having the blog users write their comments in the blog, can make advertisement to a multiplicity of persons.

Also, in the marketing support processing method according to an embodiment of the invention described below, the blog users can confirm the information on the moving or closing of shops.

Further, in the marketing support processing method according to an embodiment of the invention described below, service providers such as an internet service provider (ISP) for providing shop-aimed map information to shops can prompt a given shop closely watched by the blog users to subscribe to the service and thus can acquire a greater number of new customers.

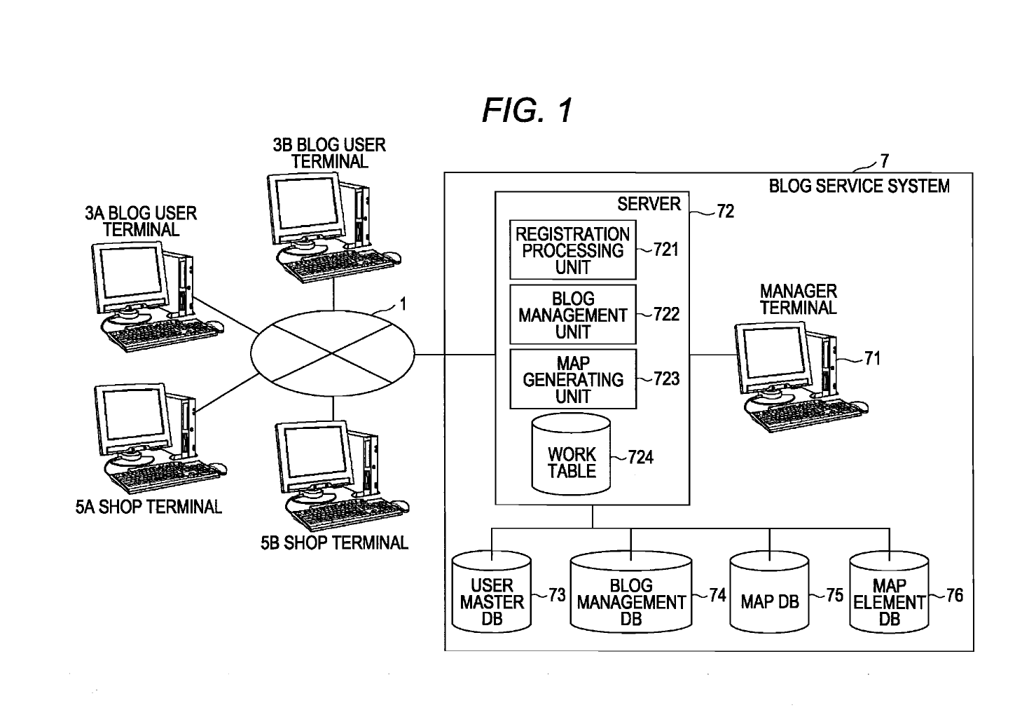

FIG. 1 shows a general configuration of a system according to an embodiment of the invention. A network 1 constituting the internet, for example, is connected with a plurality of blog user terminals 3 (blog user terminals 3A and 3B in FIG. 1), a plurality of shop terminals 5 (shop terminals 5A and 5B in FIG. 1) and a server 72 for executing the main process according to this embodiment. The blog user terminals 3 and the shop terminals 5 are each installed with, for example, a Web browser to access the server 72.

The server 72, arranged in the blog service system 7, can access a user master DB 73, a blog management DB 74, a map DB 75 and a map element DB 76 also included in the blog service system 7. The user master DB 73 has stored therein a blog user table and a shop table described later. The blog management DB 74 has stored therein blog data and a blog management table described later. The map DB 75 has stored therein data on a map. The map element DB 76 has stored therein data on map elements to be displayed on the map. Further, the server 72 is connected to a manager terminal 71 also included in the blog service system 7. Incidentally, not one but a plurality of manager terminals 71 may be included in the blog service system 7.

Also, the server 72 includes a work table 724, a registration processing unit 721 for receiving user data or shop data from the blog user terminal 3 or the shop terminal 5 to register them in the user master DB 73, a blog management unit 722 for executing the process of, for example, updating the blog data or registering favorite shops, and a map generating unit 723 for generating map data using any combinations of the user master DB 73, the blog management DB 74, the map DB 75, the map element DB 76 and the work table 724 in response to a map display request from the blog user terminal 3, the shop terminal 5 or the manager terminal 71. The work table 724 is secured in a main memory or the like in the server 72.

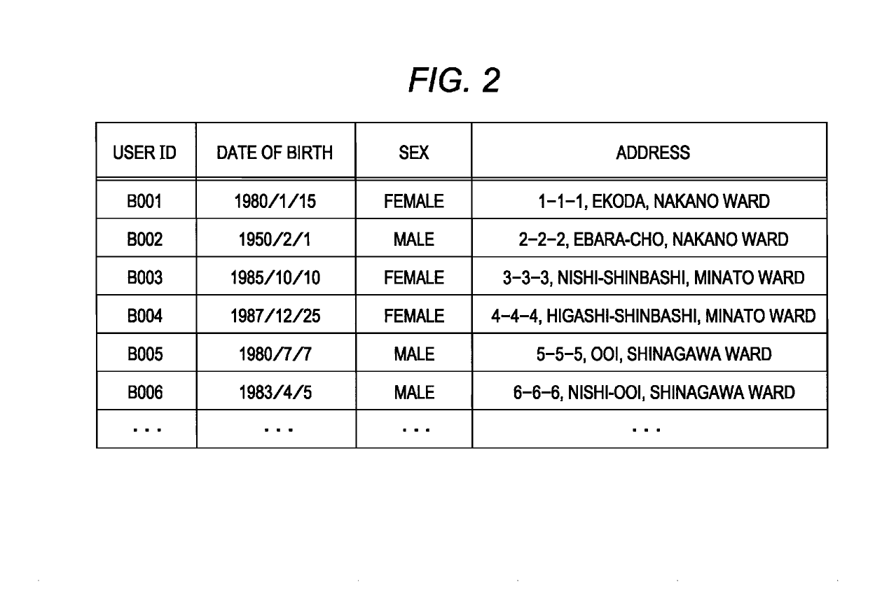

FIG. 2 shows an example of the blog user table stored in the user master DB 73. In the example shown in FIG. 2, a user ID and the date of birth, sex and address of each blog user are registered.

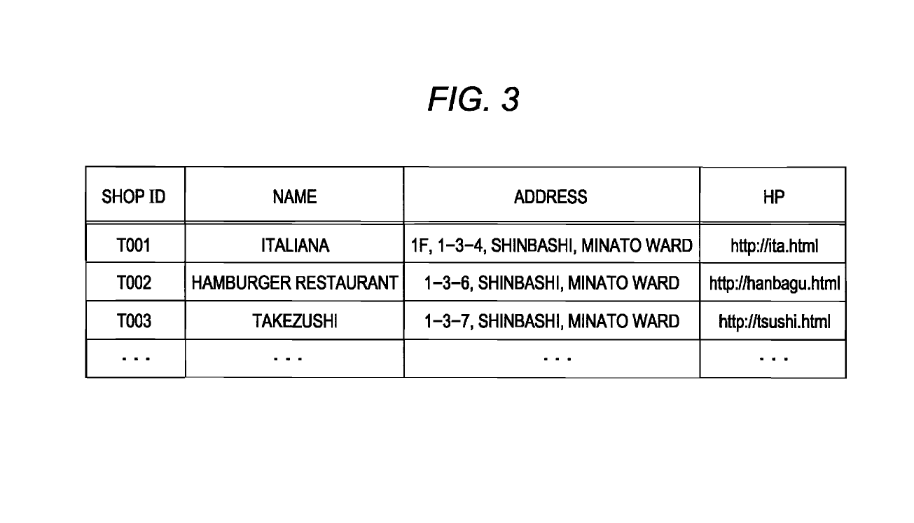

FIG. 3 shows an example of the shop table stored in the user master DB 73. In the example shown in FIG. 3, a shop ID, a shop name, a shop address and URL of a home page (HP) of each shop are registered.

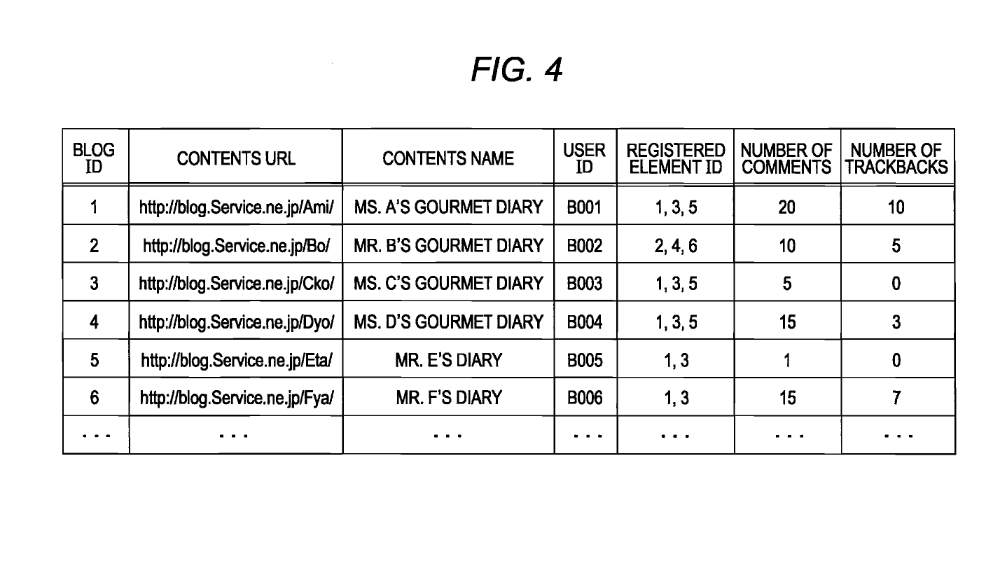

FIG. 4 shows an example of the blog management table stored in the blog management DB 74. In the example shown in FIG. 4, a blog ID, URL of contents, the name of the contents, a user ID, a registered element ID, the number of comments and the number of trackbacks are registered. In the column of the registered element ID, an element ID of each map element registered as a favorite shop in the map of the blog is stored.

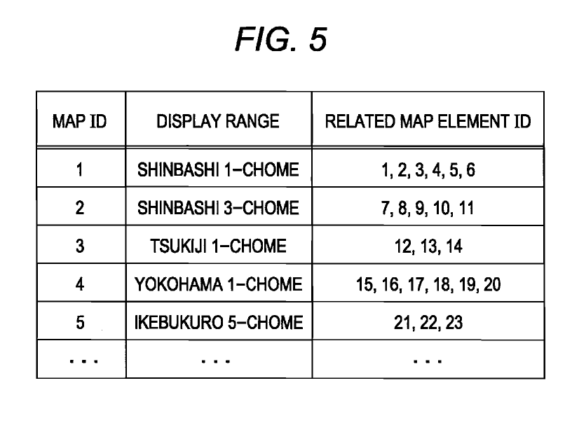

FIG. 5 shows an example of the data stored in the map DB 75. In the example of FIG. 5, a map ID, a display range (the address covered in the case under consideration) and a related map element ID of map elements included in the display range are registered. Incidentally, the map DB 75 has also registered therein map data corresponding to each map ID.

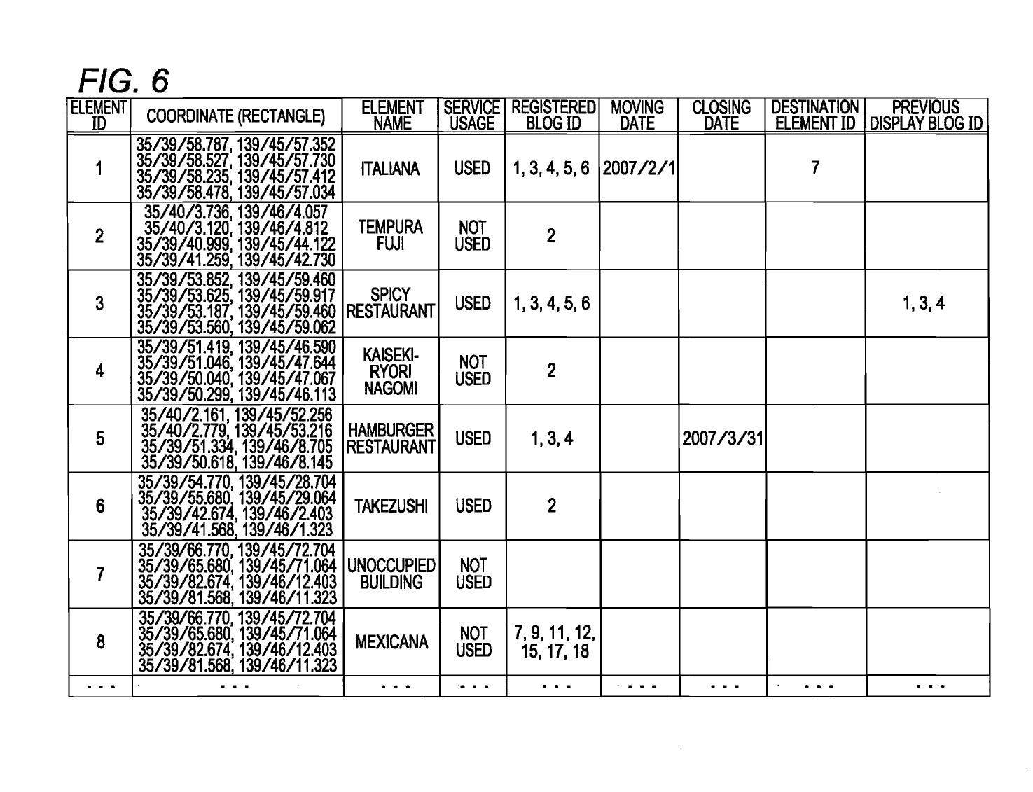

FIG. 6 shows an example of the data stored in the map element DB 76. In the example shown in FIG. 6, registered are an element ID of each map element, coordinates of a rectangle (latitude and longitude of the four points of the rectangle, for example) of the map element, an element name, service usage, a registered blog ID, a shop moving date, a shop closing date, a destination element ID and a previous display blog ID. According to this embodiment, the element ID, the coordinates of the map element rectangle and the element name are registered beforehand by the manager of the blog service system 7. The service usage column has stored therein information indicating whether a shop corresponding to a map element is using the service provided by the blog service system 7 or not. Also, the registered blog ID column has stored therein a blog ID of each blog registered with the shop corresponding to the map element as a favorite shop. Further, the closing date or the moving data and the map element ID of the destination of a shop corresponding to the map element which may be closed or moved are registered in the columns of the closing date, the moving date and the destination element ID, respectively. The previous display blog ID will be explained later.

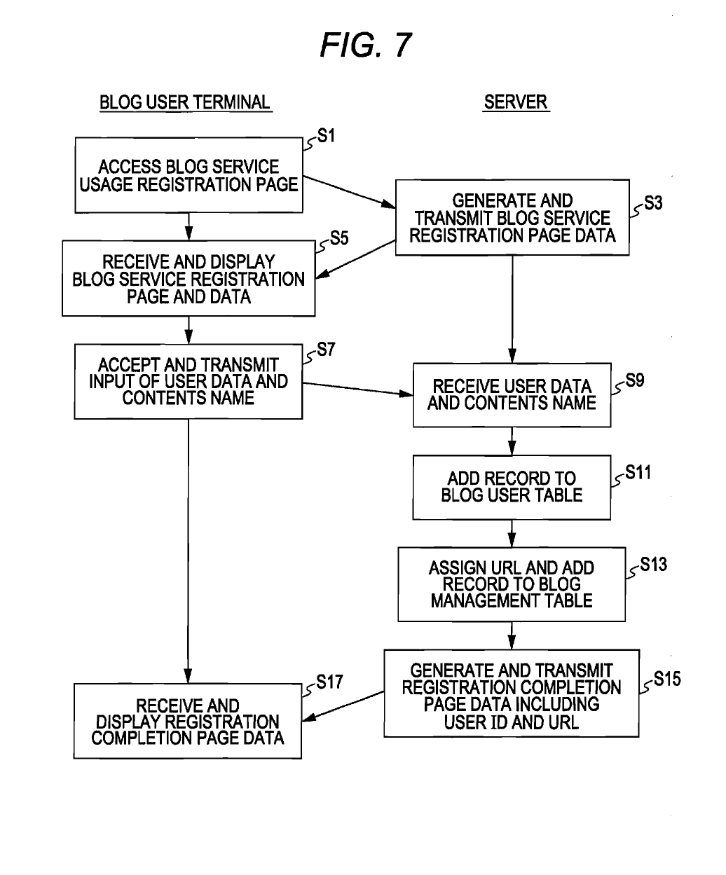

Next, with reference to FIGS. 7 to 9, the blog user registration process will be explained. First, the blog user desirous of opening his/her blog operates the blog user terminal 3 to access a blog service usage registration page of the server 72 (S1 in FIG. 7). The registration processing unit 721 of the server 72, in accordance with the access from the blog user 3, generates blog service usage registration page data and transmits it to the blog user terminal 3 (S3). The blog user terminal 3 receives the blog service usage registration page data from the server 72 and displays it on a display unit (S5).

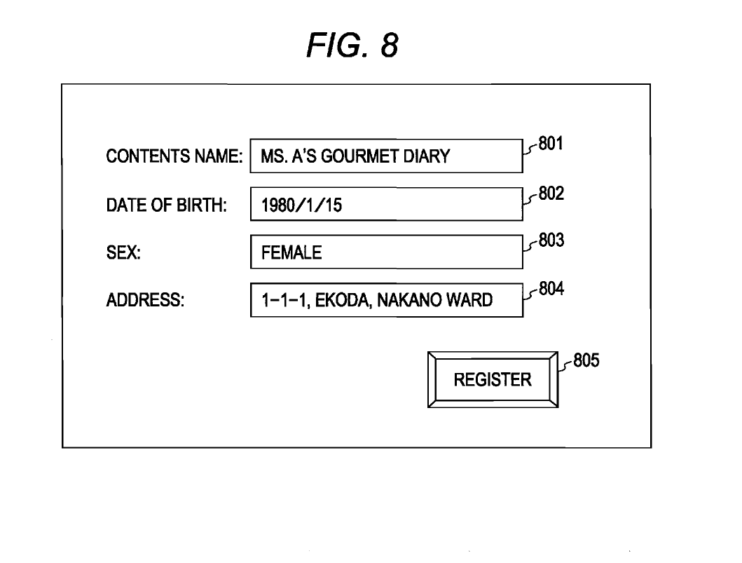

A screen shown in FIG. 8, for example, is displayed on the display unit. The blog user service usage registration screen shown in FIG. 8 includes a contents name entry column (input window/area) 801, a blog user's date of birth entry column 802, a blog user's sex entry column 803, a blog user's address entry column 804 and a register button 805. The blog user, operating the blog user terminal 3, enters data in each entry column and clicks the register button 805. The blog user terminal 3 receives the entry of the user data (i.e. the date of birth, sex and address) and the contents name, and in response to the click of the register button 805, transmits the user data and the contents name to the server 72 (S7).

The registration processing unit 721 of the server 72 receives the user data and the contents name from the blog user terminal 3 (S9), and adds the record to the blog user table based on the user data received (S11). In the process, the registration processing unit 721 assigns a user ID and registers it in the blog user table. Further, the registration processing unit 721 assigns a blog ID and URL and adds the record to the blog management table (S13). Also, the registration processing unit 721 registers the contents name and the user ID in the blog management table.

Then, the registration processing unit 721 generates registration completion page data including the user ID and URL, and transmits them to the blog user terminal 3 (S15). The blog user terminal 3 receives the registration completion page data from the server 72, and displays them on the display unit (S17).

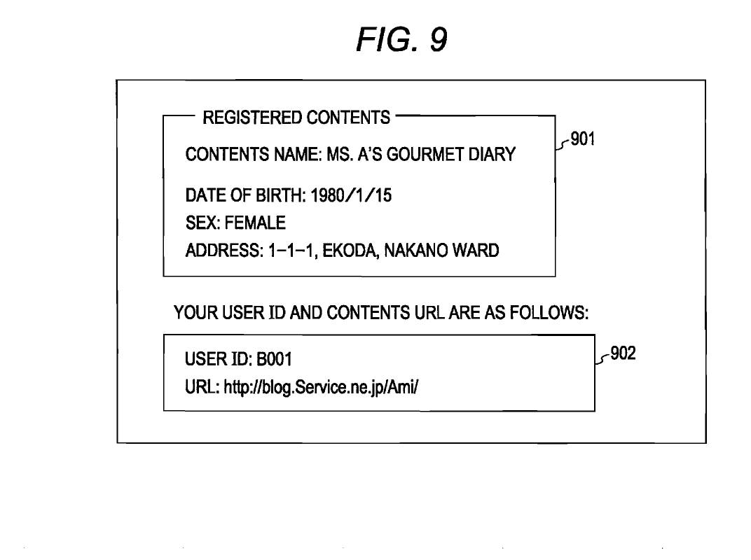

A screen shown in FIG. 9, for example, is displayed on the display unit. The registration completion screen shown in FIG. 9 includes a registered contents display column (display window/area) 901 and a column 902 for displaying a user ID and contents URL. In the case where the registered contents include an error, though not shown, the data entry may be received again.

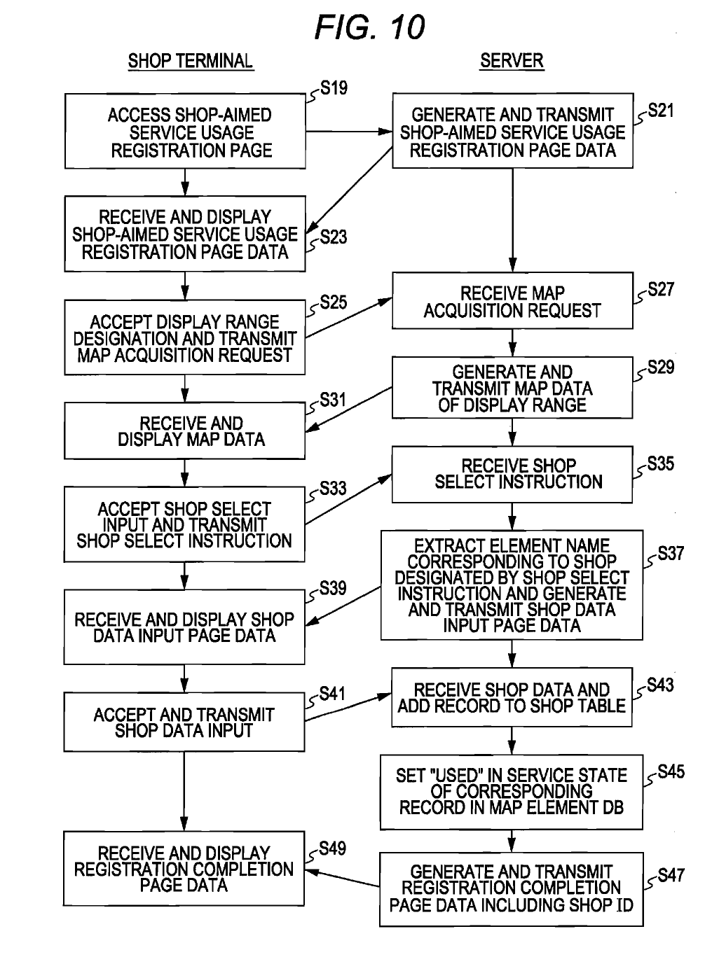

Next, with reference to FIGS. 10 to 12, the process for subscription of a shop to the service will be explained. First, a person in charge of a shop desiring to receive the service provided by the blog service system 7 operates the shop terminal 5 to access a shop-aimed service usage registration page (S19 in FIG. 10). The registration processing unit 721 of the server 72, in response to the access from the shop terminal 5, generates shop-aimed service usage registration page data and transmits it to the shop terminal 5 (S21). The shop terminal 5 receives the shop-aimed service usage registration page data from the server 72 and displays it on the display unit (S23). The person in charge of the shop operates the shop terminal 5 and inputs a display range to display a map including his/her shop. The shop terminal 5 receives a designation of the display range and transmits a map acquisition request including the display range to the server 72 (S25). The registration processing unit 721 of the server 72, upon receipt of the map acquisition request from the shop terminal 5 (S27), reads map data in the display range included in the map acquisition request from the map DB 75 while at the same time generating map data in the display range having arranged therein marks indicating related map elements to transmit them to the shop terminal 5 (S29). Then, the shop terminal 5 receives the map data from the server 72 and displays it on the display unit (S31).

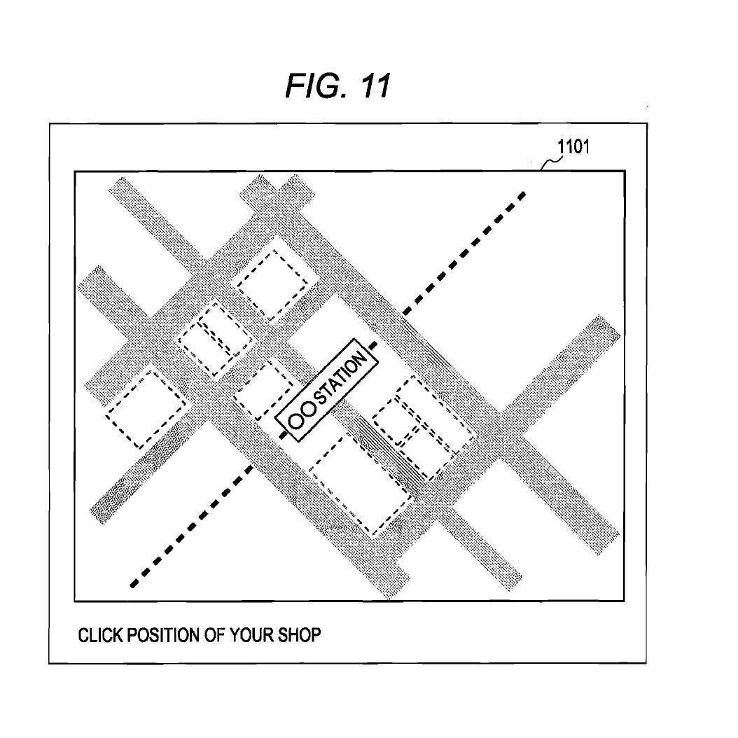

A screen shown in FIG. 11, for example, is displayed on the display unit. The shop-aimed service usage registration screen shown in FIG. 11 includes a map display column (display window/area) 1101. A person in charge of the shop operates the shop terminal 5 to click his/her shop from the shop marks (the rectangles of dotted lines in FIG. 11) displayed in the map display column 1101. The shop terminal 5 receives the shop selective entry and transmits a shop selection instruction to the server 72 (S33). The registration processing unit 721 of the server 72 receives the shop selection instruction from the shop terminal 5 (S35). The registration processing unit 721 extracts an element name corresponding to the shop designated by the shop selection instruction from the map element DB 76, generates shop data input page data including the extracted element name, and sends it to the shop terminal 5 (S37). The shop terminal 5 receives the shop data input page data from the server 72 and displays it on the display unit (S39).

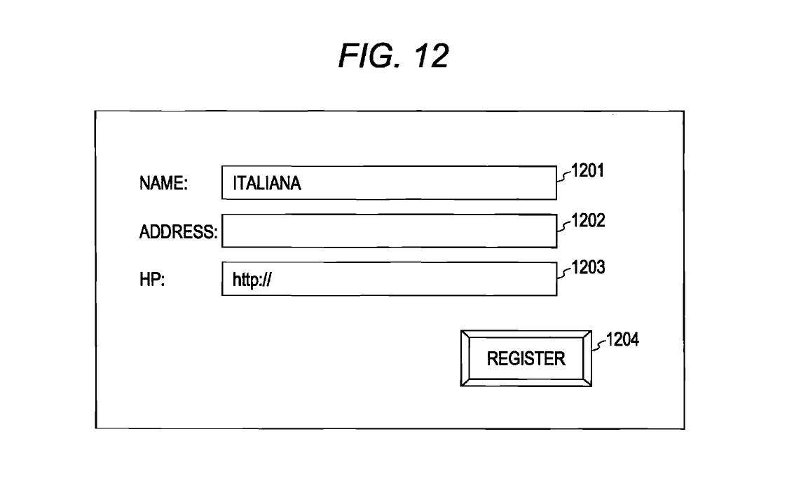

A screen shown in FIG. 12, for example, is displayed on the display unit. The shop data input screen shown in FIG. 12 includes a shop name entry column 1201, a shop address entry column 1202, a shop's home page entry column 1203 and a register button 1204. An element name, if registered in the map element DB 76, is displayed beforehand in the shop name entry column 1201. A person in charge of the shop, operating the shop terminal 5, inputs the data in each entry column and clicks the register button 1204. The shop terminal 5 receives the entry of the shop data (i.e. the name, address and home page), and in response to the click of the register button 1204, transmits the shop data to the server 72 (S41).

The registration processing unit 721 of the server 72 receives the shop data from the shop terminal 5, and adds the record to the shop table based on the received shop data (S43). In the process, the registration processing unit 721 assigns a shop ID and registers it in the shop table. Also, the registration processing unit 721 sets the service usage of the record to “used” as to the map element corresponding to the shop in the map element DB 76 (S45). The registration processing unit 721 generates registration completion page data including the shop ID and transmits it to the shop terminal 5 (S47). The shop terminal 5 receives the registration completion page data from the server 72 and displays it on the display unit (S49).

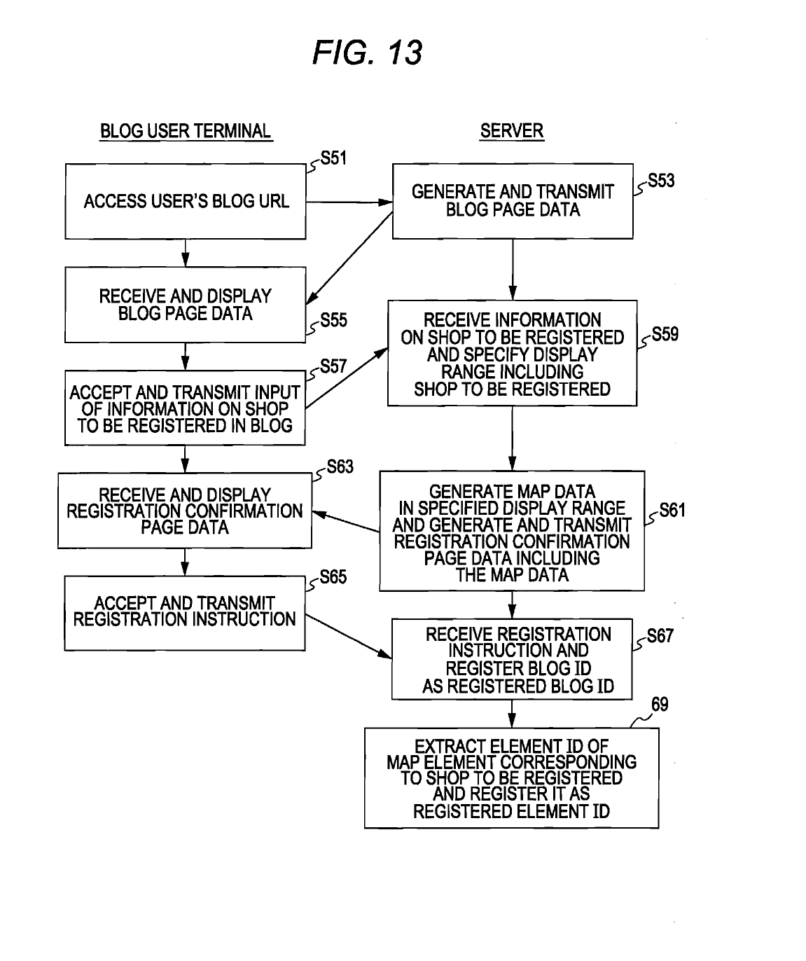

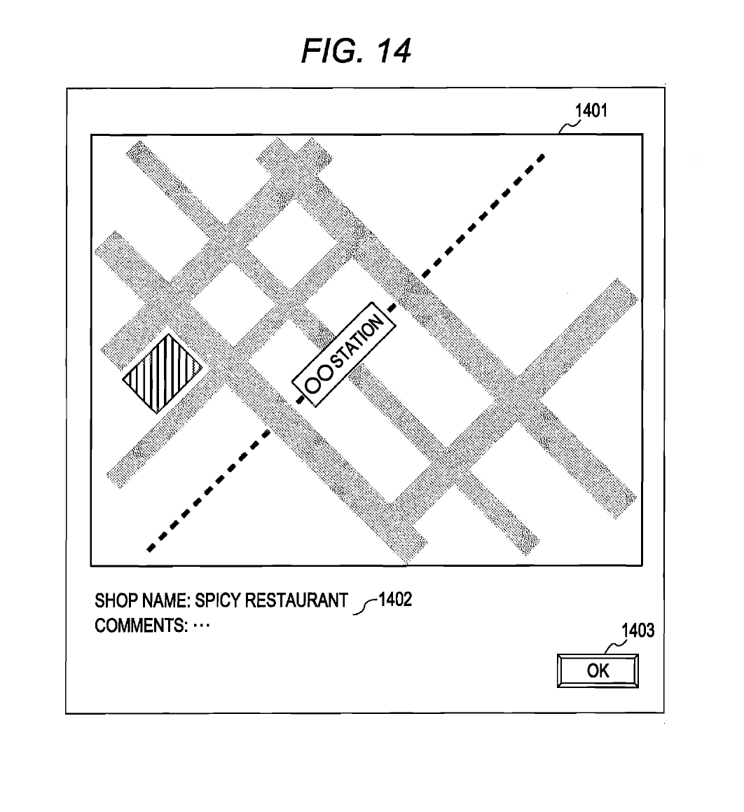

Next, with reference to FIGS. 13 and 14, the process in which the user registers a favorite shop in the map of his/her blog will be explained. First, the blog user, operating the blog user terminal 3, accesses the URL of his/her blog (S51 in FIG. 13). The blog management unit 722 of the server 72, in response to the access from the blog user terminal 3, generates blog page data for the blog user and transmits it to the blog user terminal 3 (S53). The blog user terminal 3 receives the page data of the blog and displays it on the display unit (S55). Then, the blog user operating the blog user terminal 3 entries information on the shop (such as the shop name, shop position information, comments on the shop, etc.) to be registered in the blog. The blog user terminal 3, receiving the entry of the shop information to be registered, transmits it to the server 72 (S57). Though not shown, assume that the authentication process is completed before the process of S57 and the user ID and the blog ID are stored in the storage unit of the server 72. The blog management unit 722 of the server 72 receives the information on the shop to be registered and specifies a display range including the shop to be registered (S59). Then, the blog management unit 722 reads map data in the specified display range from the map DB 75 on the one hand, and generates the map data having arranged therein the mark indicating the shop to be registered while at the same time generating registration confirmation page data including the map data and transmitting it to the blog user terminal 3 on the other hand (S61). The blog user terminal 3 receives the registration confirmation page data and displays it on the display unit (S63).

A screen shown in FIG. 14, for example, is displayed on the display unit. The registration confirmation screen shown in FIG. 14 includes a map display column 1401, a shop information display column 1402 and an OK button 1403. The blog user checks a shop position and shop information and when confirming that they are free of any problem, operates the blog user terminal 3 to click the OK button 1403. The blog user terminal 3 receives a registration instruction and transmits it to the server 72 (S65). Then, the blog management unit 722 of the server 72, upon receipt of the registration instruction from the blog user terminal 3, registers, as a registered blog ID, a blog ID held in the storage unit in the record for the map element corresponding to the shop to be registered in the map element DB 76 (S67). Further, the blog management unit 722 extracts, from the map element DB 76, an element ID of the map element corresponding to the shop to be registered, and registers it as a registered element ID in the record including the blog ID in the blog management table (S69).

By executing the aforementioned process, an element ID of a registree is set in the column of the registered element ID of the blog management table in DB 74, while a blog ID of a registerer is set in the column of the registered blog ID of the map element DB 76. Thus, the correlation between the element ID of the registree and the blog ID of the registerer is more easily managed.

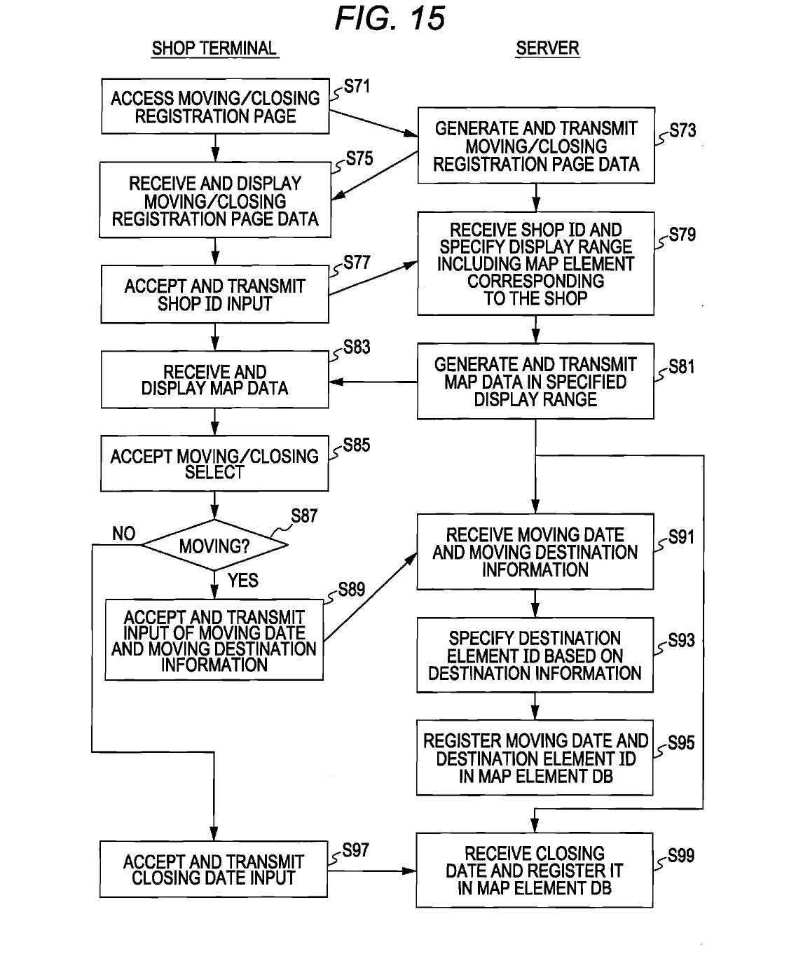

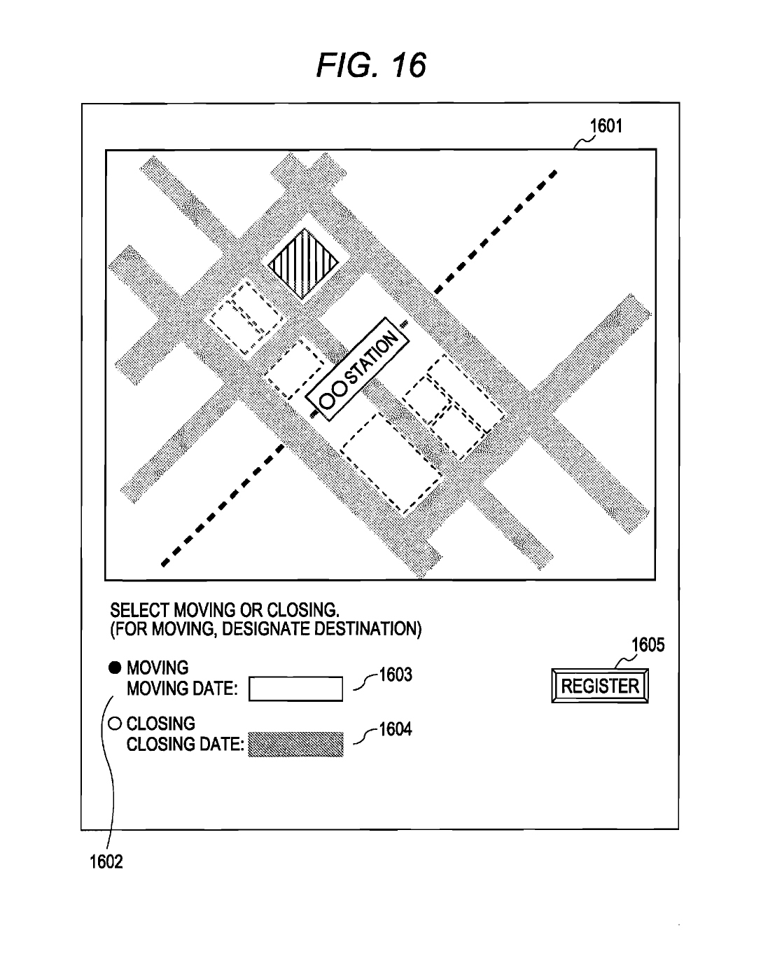

Next, with reference to FIGS. 15 and 16, the process of registering shop moving or closing information will be explained. First, a person in charge of a shop of which the moving or closing has been determined operates the shop terminal 5 to access a shop moving/closing registration page (S71 in FIG. 15). The registration processing unit 721 of the server 72, in response to the access from the shop terminal 5, generates moving/closing registration page data and transmit it to the shop terminal 5 (S73). The shop terminal 5 receives the moving/closing registration page data from the server 72 and displays it on the display unit (S75). The person in charge of the shop operates the shop terminal 5 to enter the shop ID. The shop terminal 5 receives the entry of the shop ID and transmits it to the server 72 (S77). Though not shown, the authentication process is completed, if not executed in advance. The registration processing unit 721 of the server 72, upon receipt of the shop ID from the shop terminal 5, specifies a display range including a map element corresponding to the shop by referring to the shop table and the map element DB 76 (S79). Map data in the specified display range is read from the map DB 75 on the one hand, and the map data for the display range having arranged therein marks indicating related map elements and highlighting the map element corresponding to the particular shop is generated and transmitted to the shop terminal 5 at the same time (S81). The shop terminal 5 receives the map data from the server 72 and displays it on the display unit (S83).

A screen shown in FIG. 16, for example, is displayed on the display unit. The shop moving/closing registration screen shown in FIG. 16 includes a map display column 1601, a moving/closing selection radio button 1602, a shop moving date entry column 1603, a shop closing data entry column 1604 and a register button 1605. A person in charge of a shop, after confirming the position of his/her shop (the shop indicated by halftone dot meshing in FIG. 16) in the map display column 1601, operates the shop terminal 5 to select “shop moving” or “shop closing” with the radio button 1602, and enters the moving date or the closing date, as the case may be, in the moving date entry column 1603 or the closing date entry column 1604, respectively. In the case where “moving” is selected by the radio button 1602, the person in charge of the shop operates the shop terminal 5 and further clicks the destination in the map display column 1601. The shop terminal 5 receives the selection of moving or closing (S85), and determines whether “moving” is selected or not (S87). In the case where “moving” is selected (route to YES in S87), the entry of the moving date and the destination information is received, and in response to the click of the register button 1605, the moving date and the destination information are transmitted to the server 72 (S89). Incidentally, in the example of the screen shown in FIG. 16, “moving” is selected by the radio button 1602, and therefore, no data can be entered in the shop closing date entry column 1604.

The registration processing unit 721 of the server 72, upon receipt of the moving date and the destination information from the shop terminal 5 (S91), specifies the element ID of the map element of the destination based on the destination information (S93). The registration processing unit 721 registers the element ID of the map elements of the moving date and the destination in the record in the map element DB 76 (S95). This element ID is registered as a destination element ID.

In the case where “closing” is selected (route to NO in S87), on the other hand, the entry of the closing date is received, and in response to the click of the register button 1605, the data on the closing date is transmitted to the server 72 (S97). Then, the registration processing unit 721 of the server 72 receives the data on the shop closing date from the shop terminal 5 and registers it in the record in the map element DB 76 (S99). The embodiments are not limited to shop closing and/or moving information, and other shop related data or shop information managing data or shop marketing information can be provided.

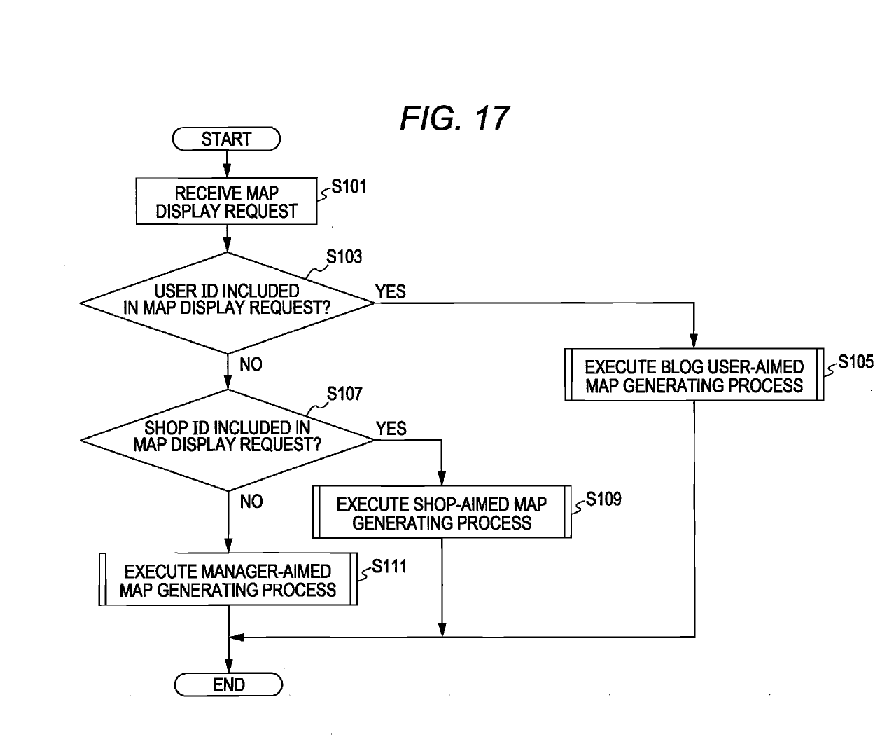

Next, the process executed upon receipt of the map display request from the blog user terminal 3, the shop terminal 5 or the manager terminal 71 will be explained with reference to FIGS. 17 to 27. First, the blog user, the person in charge of the shop or the manager of the blog service system 7 operates the blog user terminal 3, the shop terminal 5 or the manager terminal 71, respectively, to transmit the map display request to the server 72. Though not shown, assume that the authentication process for the blog user and the shop is completed. Also, according to this embodiment, assume that the map display request contains the blog user ID, the shop ID or the manager ID as the information for specifying the transmitter of the map display request.

The map generating unit 723 of the server 72 receives the map display request from the blog user terminal 3, the shop terminal 5 or the manager terminal 71 (S101). Then, with reference to the blog user table, the map generating unit 723 determines whether the map display request contains a user ID or not (S103).

Upon determination that the map display request contains no user ID (route to YES in S103), the map generating unit 723 executes the process of generating a blog user-aimed map using the blog management DB 74, the map DB 75, the map element DB 76 and the work table 724 (S105). The blog user-aimed map generating process will be explained in detail later.

Upon determination that the user ID is not included in the map display request (route to NO in S103), on the other hand, the map generating unit 723 determines whether the shop ID is included in the map display request or not using the shop table (S107). Upon determination that the shop ID is included in the map display request (route to YES in S107), the map generating unit 723 executes the shop-aimed map generating process using the user master DB 73, the blog management DB 74, the map DB 75, the map element DB 76 and the work table 724 (S109). The shop-aimed map generating process will be explained in detail later.

Upon determination that the shop ID is not included in the map display request (route to NO in S107), i.e. in the case where the manager ID is included in the map display request, on the other hand, the map generating unit 723 executes a manager-aimed map generating process using the user master DB 73, the blog management DB 74, the map DB 75, the map element DB 76 and the work table 724 (S111). The manager-aimed map generating process will be explained in detail later.

The map generating unit 723 ends the process after executing the blog user-aimed map generating process (S105), the shop-aimed map generating process (S109) or the manager-aimed map generating process (S111).

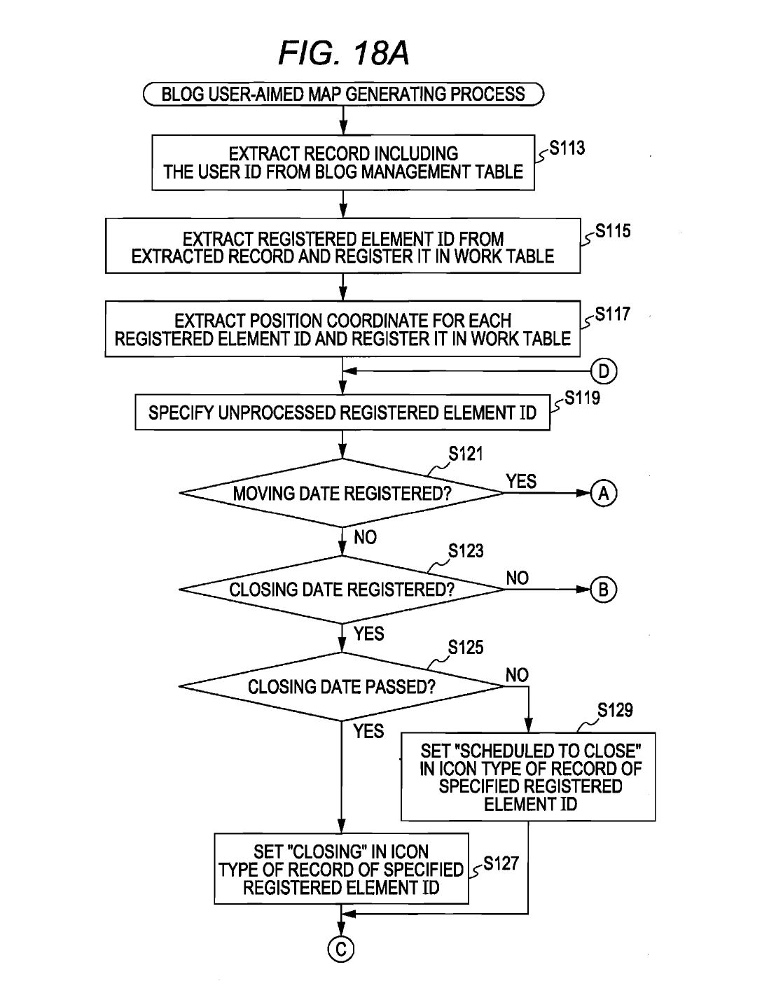

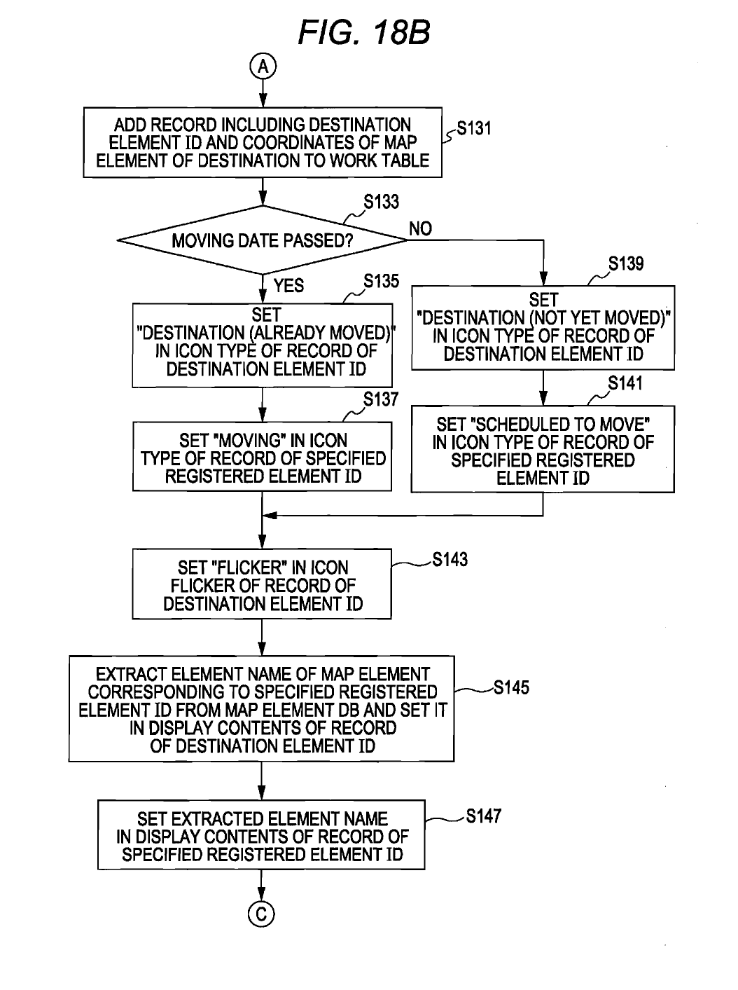

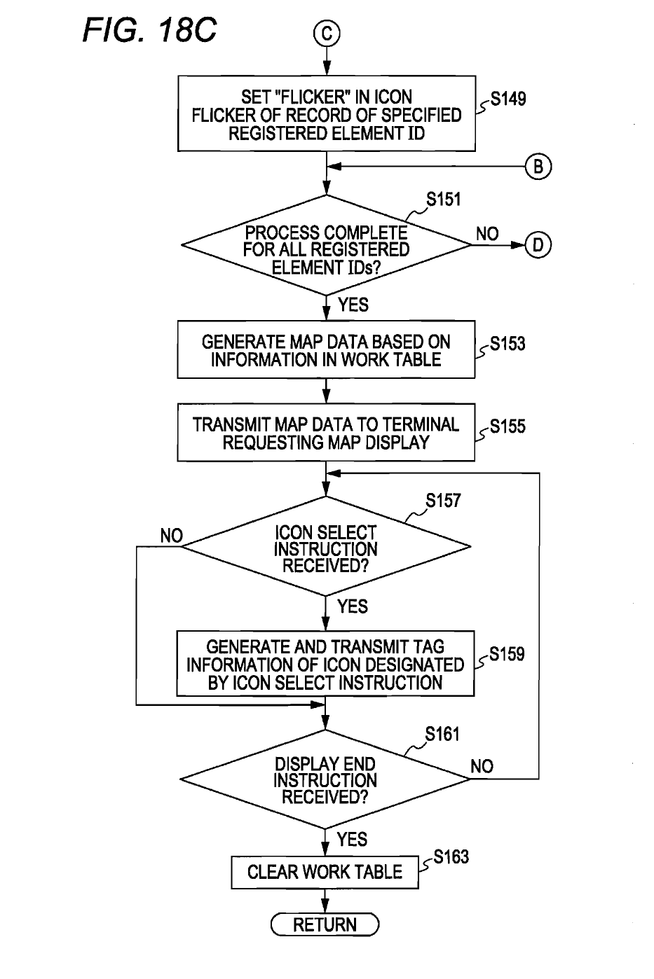

Next, the blog user-aimed map generating process executed in S105 shown in FIG. 17 will be explained with reference to FIGS. 18 to 21. First, the map generating unit 723 of the server 72 extracts a record including the user ID from the blog management table (S113 in FIG. 18A). Then, the map generating unit 723 extracts the registered element ID from the extracted record and registers it in the work table 724 (S115). Also, the map generating unit 723 extracts the coordinates from the map element DB 76 and registers it in the work table 724 for each registered element ID (S117).

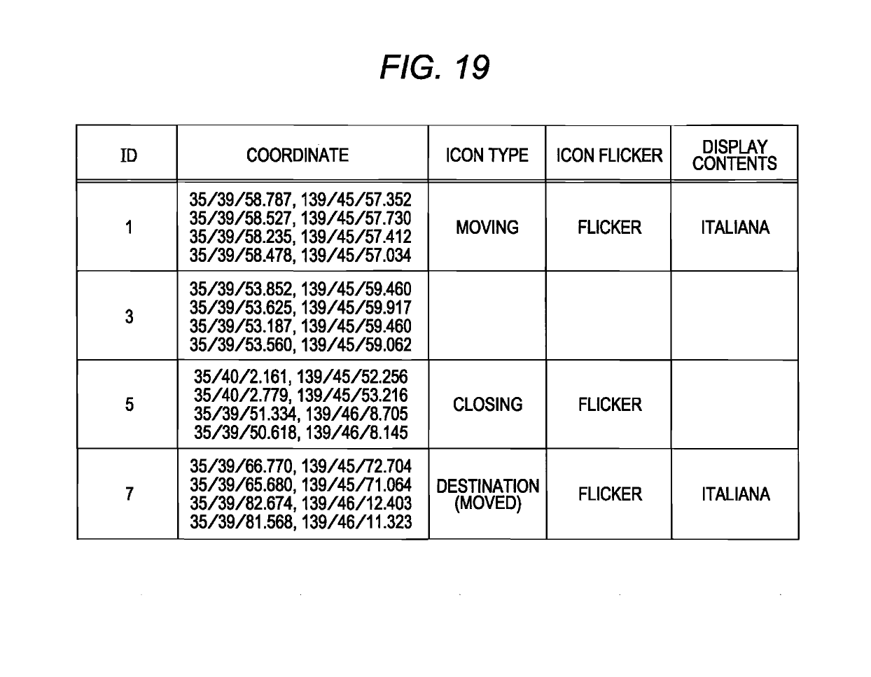

FIG. 19 shows an example of data stored in the work table 724. In the case of FIG. 19, registered are an ID, coordinates, an icon type, an icon flicker and display contents. In the “icon type” column, any one of “closing”, “scheduled to close”, “moving”, “scheduled to move”, “destination (moved)” or “destination (not yet moved)” is set in the case where the shop is scheduled to move or close. Unless the shop is scheduled to move or close, on the other hand, these columns remain blank. In the case where the icon is displayed in flicker, “flicker” is set in “icon flicker” column. The display contents will be explained later. Nothing is set as of this timing, although the data is set in the “icon type”, “icon flicker” and “display contents” columns in FIG. 19.

The map generating unit 723 specifies an unprocessed registered element ID in the work table 724 (S119). The map generating unit 723 determines whether the moving date is registered or not by accessing the map element DB 76 based on the specified registered element ID (S121).

Upon determination that the moving date is not registered (route to NO in S121), the map generating unit 723 refers to the map element DB 76 based on the specified registered element ID and determines whether the closing date is registered or not (S123). Upon determination that the closing date is not registered (route to NO in S123), the process proceeds to S151 (FIG. 18C) through a flowchart connector terminal B. Upon determination that the closing date is registered (route to YES in S123), on the other hand, the map generating unit 723 acquires the current date and determines whether the closing date has passed or not (S125). Upon determination that the closing date has passed (route to YES in S125), the map generating unit 723 sets “closing” in the icon type of the record of the specified registered element ID in the work table 724 (S127). Upon determination that the closing date has not passed (route to NO in S125), on the other hand, the map generating unit 723 sets “scheduled to close” in the icon type of the record of the specified registered element ID in the work table 724 (S129). After the process of S127 or S129, the process proceeds to S149 (FIG. 18C) through a flowchart connector terminal C.

Upon determination that the moving date is registered in S121 (route to YES in S121), on the other hand, the process proceeds to S131 (FIG. 18B) through a flow chart connector terminal A.

Referring to the process shown in FIG. 18B, the map generating unit 723 adds the record including the destination element ID and the coordinate of the destination map element to the work table 724 (S131 in FIG. 18B). Then, the map generating unit 723, acquiring the current date, determines whether the moving date has passed or not (S133).

Upon determination that the moving date has passed (route to YES in S133), the map generating unit 723 sets “destination (already moved)” in the icon type of the record of the destination element ID in the work table 724 (S135). Further, the map generating unit 723 sets “moving” in the icon type of the record of the specified registered element ID in the work table 724 (S137).

Upon determination that the moving date has not passed (route to NO in S133), on the other hand, the map generating unit 723 sets “destination (not yet moved)” in the icon type of the record of the destination element ID in the work table 724 (S139). Further, the map generating unit 723 sets “scheduled to move” in the icon type of the record of the specified registered element ID in the work table 724 (S141).

After the process of S137 or S141, the map generating unit 723 sets “flicker” in the “icon flicker” column of the record of the destination element ID in the work table 724 (S143). Also, the map generating unit 723 extracts a element name of the map element corresponding to the specified registered element ID from the map element DB 76 and sets it in the display contents of the record of the destination ID in the work table 724 (S145). Further, the map generating unit 723 sets the extracted element name in the display contents of the record of the specified registered element ID in the work table 724 (S147). Then, the process proceeds to S149 (FIG. 18C) through the flowchart connector terminal C.

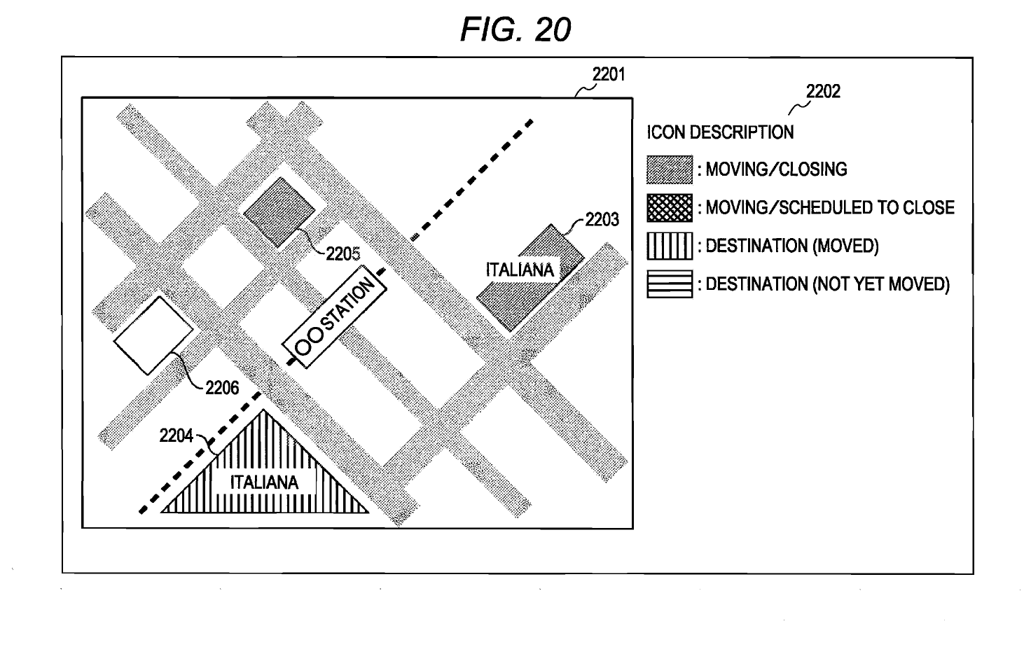

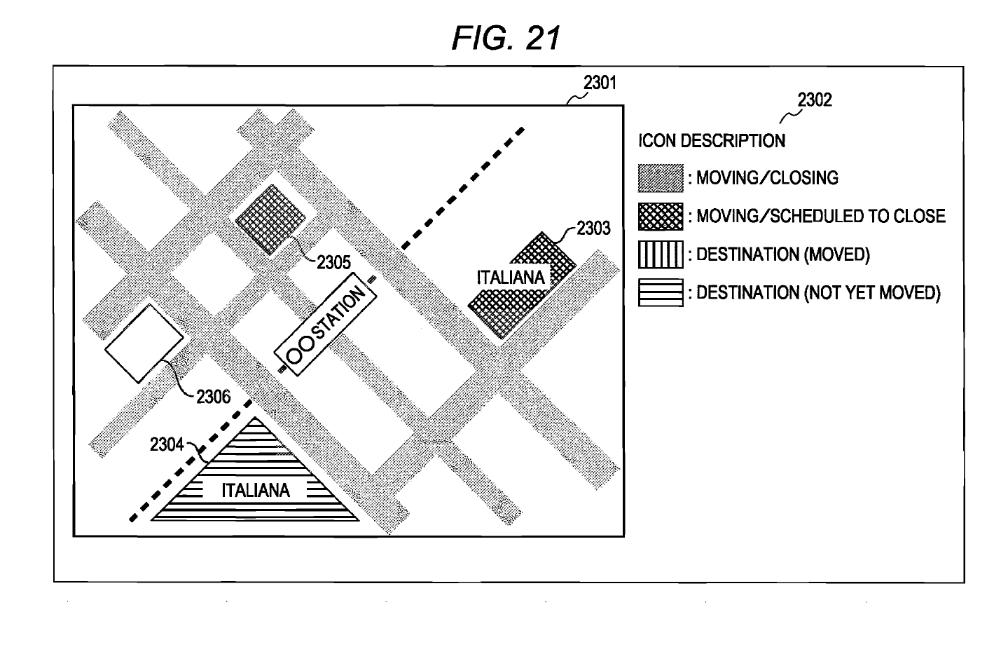

Referring to the process of FIG. 18C, the map generating unit 723 sets “flicker” in the “icon flicker” column of the record of the specified registered element ID in the work table 724 (S149 in FIG. 18C). Then, the map generating unit 723 determines whether the process is complete or not for all the registered element IDs (S151). In the case where the process for all the registered element IDs is not complete (route to NO in S151), the process returns to S119 (FIG. 18A) through a flowchart connector terminal D. Upon completion of the process for all the registered element IDs (route to YES in S151), on the other hand, the map generating unit 723 reads map data in the display range from the map DB 75, while at the same time generating map data having arranged therein a mark indicating the map element corresponding to the element ID stored in the work table 724 (S153). In the process, the manner in which the mark is displayed is specified in accordance with the data stored in the work table 724. Then, the map generating unit 723 transmits the generated map data to the terminal issuing the map display request (i.e. the blog user terminal 3) (S155). The blog user terminal 3 receives the map data from the server 72 and displays it on the display unit. A screen shown in FIG. 20 or 21, for example, is displayed on the display unit. The map display screen shown in FIG. 20 includes a map display column 2201 and an icon description column 2202. Icons 2203 to 2206 are displayed in the map display column 2201. As clear from FIG. 20, the shop “Italiana” of the icon 2203 is already moved to the position of the icon 2204, and the shop of the icon 2205 is shown to be closed already.

Similarly, the map display screen shown in FIG. 21 includes a map display column 2301 and an icon description column 2302. Icons 2303 to 2306 are displayed in the map display column 2301. FIG. 21 shows that the shop “Italiana” of the icon 2303 is scheduled to move to the position of the icon 2304, and the shop of the icon 2305 is scheduled to close.

Also, the map generating unit 723 determines whether an icon selection instruction from the blog user terminal 3 is received or not (S157). Assuming that any icon is clicked by the blog user on the map display screen shown in FIG. 20 or 21, for example, the blog user terminal 3 transmits the icon selection instruction including identification information of a selected icon to the server 72. Upon receipt of the icon selection instruction (route to YES in S157), the map generating unit 723 generates tag information (e.g., speech bubble, etc.) of the icon designated by the icon selection instruction and transmits it to the blog user terminal 3 (S159). The blog user terminal 3, upon receipt of the tag information from the server 72, displays the tag on the map display screen shown in FIG. 20 or 21. Though not shown, the moving date or the closing date is displayed on the tag.

In the case where the icon selection instruction is not received (route to NO in S157), on the other hand, the map generating unit 723 determines whether a display end instruction is received or not (S161). In the case where the display end instruction is not received (route to NO in S161), the process returns to S157. Upon receipt of the display end instruction (route to YES in S161), on the other hand, the map generating unit 723 clears the work table 724 (S163) and the process is returned to the original one.

By executing the process described above, the blog user can confirm the information on the moving or closing of the shop.

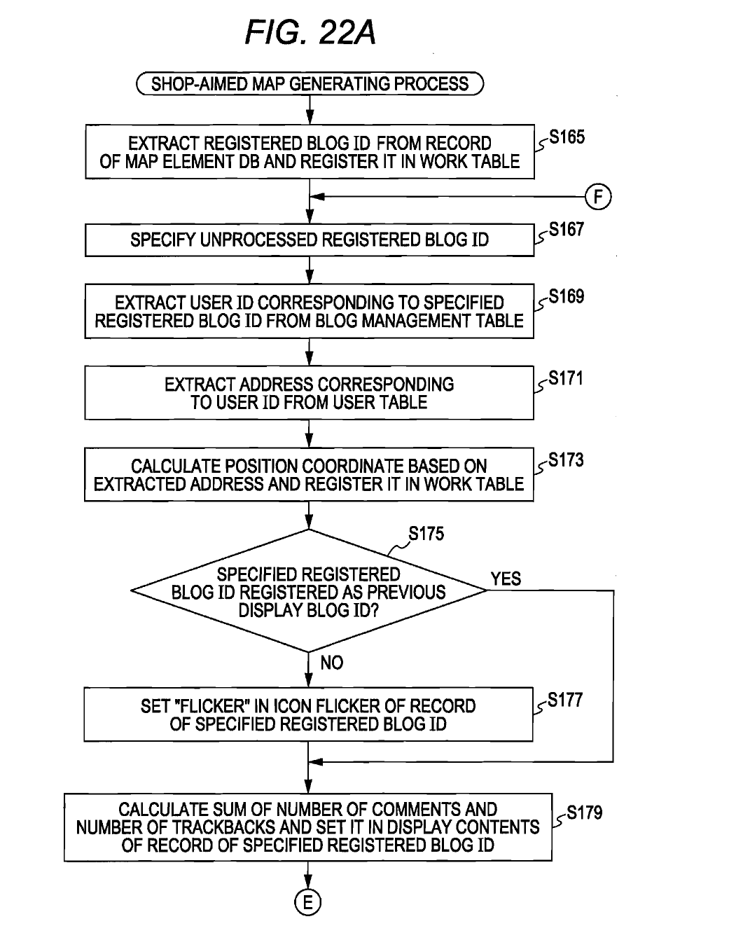

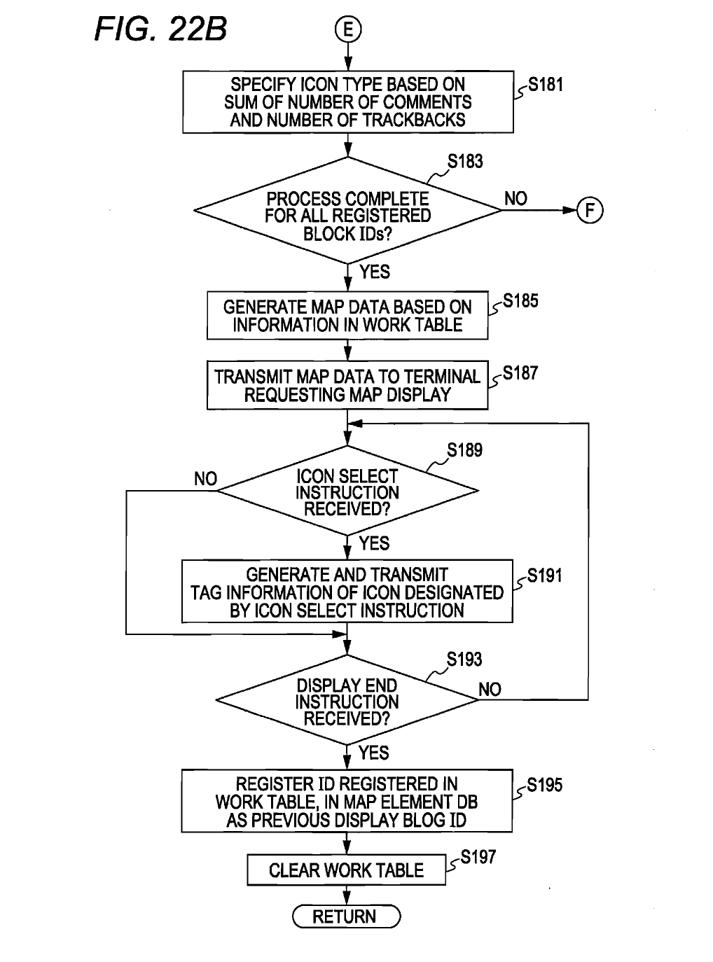

Next, with reference to FIGS. 22A to 24, the shop-aimed map generating process executed in S109 of FIG. 17 will be explained. First, the map generating unit 723 of the server 72 extracts a registered blog ID from the record of the map element corresponding to the shop in the map element DB 76 and registers it in the work table 724 (S165 in FIG. 22A).

Then, the map generating unit 723 specifies an unprocessed registered blog ID in the work table 724 (S167). The map generating unit 723 searches the blog management table based on the specified registered blog ID, extracts a user ID corresponding to the specified registered blog ID, and stores it in the storage unit (S169). Further, the map generating unit 723 searches the blog user table based on the extracted user ID, extracts an address corresponding to the user ID, and stores it in the storage unit (S171). The map generating unit 723 then calculates the position coordinate based on the extracted address, and registers it at the coordinate of the record of the specified registered blog ID of the work table 724 (S173).

The map generating unit 723 determines whether the specified registered blog ID is registered in the map element DB 76 as a previous display blog ID or not (S175). Upon determination that the specified registered blog ID is not registered in the map element DB 76 as the previous display blog ID (route to NO in S175), the map generating unit 723 set “flicker” in the “icon flicker” column of the record of the specified registered blog ID in the work table 724 (S117). Upon determination that the specified registered blog ID is registered in the map element DB 76 as the previous display blog ID (route to YES in S175), on the other hand, the process skips S177 and proceeds to S179.

The map generating unit 723 calculates the sum of the number of comments and the number of trackbacks corresponding to the registered blog ID, the numbers being stored in the blog management table, and sets it in the display contents of the record of the specified registered blog ID in the work table 724 (S179). Then, the process proceeds to S181 (FIG. 22B) through a flowchart connector terminal E.

Referring to the process shown in FIG. 22B, the map generating unit 723 specifies the icon type based on the sum of the number of comments and the number of trackbacks stored in the work table 724 (S181 in FIG. 22B). In other words, the degree of conspicuousness of the blog is determined based on the sum of the number of comments and the number of trackbacks, and the manner in which the icon is displayed is determined by the degree of conspicuousness. According to this embodiment, the degree of conspicuousness is determined as “high” in the case where the sum of the number of comments and the number of trackbacks is not less than 20. In the case where the sum of the number of comments and the number of trackbacks is less than 20 and not less than 10, on the other hand, the degree of conspicuousness is determined as “middle” (“medium”). Further, in the case where the sum of the number of comments and the number of trackbacks is less than 10, the degree of conspicuousness is determined as “low”. The embodiments are not limited to such a blog degree of conspicuousness determination and blog conspicuousness can be determined by other methods.

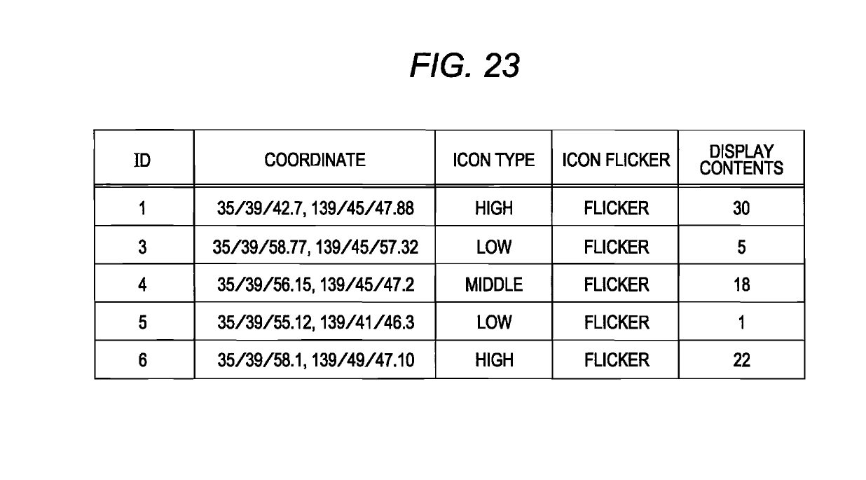

FIG. 23 shows an example of the data stored in the work table 724. In the example shown in FIG. 23, the ID, the coordinate, the icon type, the icon flicker and the display contents are registered. The column “icon type” has set therein “high”, “middle” and “low” in accordance with the degree of conspicuousness, as described above. Also, in the case where the specified registered blog ID is not registered in the map element DB 76 as the previous display blog ID, “flicker” is set in the column “icon flicker”. The column “display contents” has set therein the sum of the number of comments and the number of trackbacks.

The map generating unit 723 determines whether the process is completed for all the registered blog IDs or not (S183). In the case where the process is not yet complete for all the registered blog IDs (route to NO in S183), the process returns to S167 (FIG. 22A) through a flowchart connector terminal F. Upon completion of the process for all the registered blog IDs (route to YES in S183), on the other hand, the map generating unit 723 reads map data in the display range from the map DB 75, while at the same time generating map data having arranged therein icons indicating respective blogs in accordance with the data stored in the work table 724 (S185). In the process, the manner in which the marks are displayed is determined in accordance with the data stored in the work table 724. Then, the map generating unit 723 transmits the map data generated to the terminal issuing the map display request (i.e. the shop terminal 5) (S187). The shop terminal 5 receives the map data from the server 72 and displays it on the display unit.

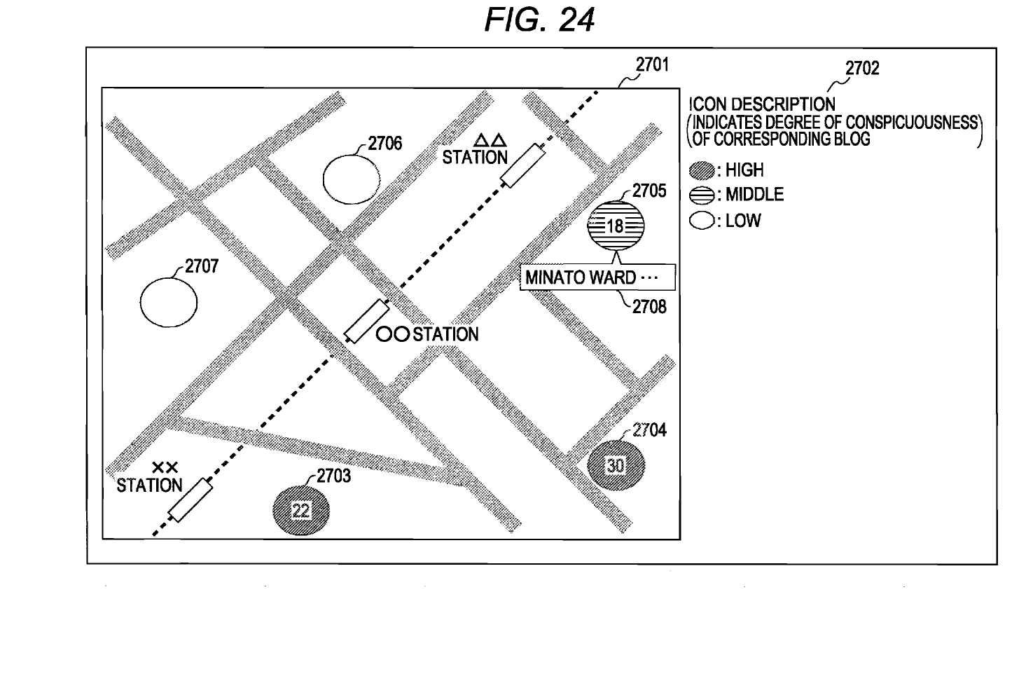

A screen shown in FIG. 24, for example, is displayed on the display unit. The map display screen of FIG. 24 includes a map display column 2701 and an icon description column 2702. Icons 2703 to 2707 are displayed in the map display column 2701. The icons 2703 to 2707 indicate that the blog user of the blog having registered his/her shop exists in that area. Further, according to this embodiment, the icon is displayed in the manner of display corresponding to the degree of conspicuousness of the blog. The icons 2703 and 2704, for example, indicate that a blog user of a blog regarded to have the “high” degree of conspicuousness exists in that area. Also, the icon 2705 indicates that a blog user of a blog regarded to have the “middle” degree of conspicuousness exists in that area. Further, the icons 2706 and 2707 indicate that a blog user of a blog regarded to have the “low” degree of conspicuousness exists in that area. The degree of conspicuousness of the blog, however, is not necessarily limited to the three categories described above.

Also, the map generating unit 723 determines whether the icon selection instruction is received or not from the shop terminal 5 (S189). For example, in the case where any icon is clicked by the person in charge of the shop on the map display screen shown in FIG. 24, the shop terminal 5 transmits the icon selection instruction including identification information of a selected icon to the server 72. Upon receipt of the icon selection instruction (route to YES in S189), the map generating unit 723 generates tag information of the icon designated by the icon selection instruction and transmits it to the shop terminal 5 (S191). The shop terminal 5, upon receipt of the tag information from the server 72, displays a tag on the map display screen of FIG. 24. For example, a tag 2708 (FIG. 24) is displayed. In the case of FIG. 24, the registered address “Minato Ward . . . ” is displayed. Incidentally, a part of the registered address may not be disclosed for privacy protection. Though not shown, the sex and the age may also be displayed together with the registered address. Further, a link to the corresponding blog may be included.

In the case where the icon selection instruction is not received (route to NO in S189), on the other hand, the map generating unit 723 determines whether a display end instruction is received or not (S193). In the case where the display end instruction is not received (route to NO in S193), the process returns to S189. Upon receipt of the display end instruction (route to YES in S193), on the other hand, the registered blog ID in the work table 724 is registered in the map element DB 76 as the previous display blog ID by the map generating unit 723 (S195). For example, in the case where the shop-aimed map generating process is executed in response to the map display request from the shop “Italiana” and the data shown in FIG. 23 is stored in the work table 724, IDs “1”, “3”, “4”, “5” and “6” are registered in the record corresponding to the shop “Italiana” in the map element DB 76 as the previous display blog ID. Thereafter, the map generating unit 723 clears the work table 724 (S197), and the process returns to the first step.

By executing the process described above, the person in charge of the shop (e.g., shop owner or manager) can grasp the distribution of the addresses of the blog users of the blog having their (shop owner's) shops registered and the degree of conspicuousness of each blog and can utilize them for marketing.

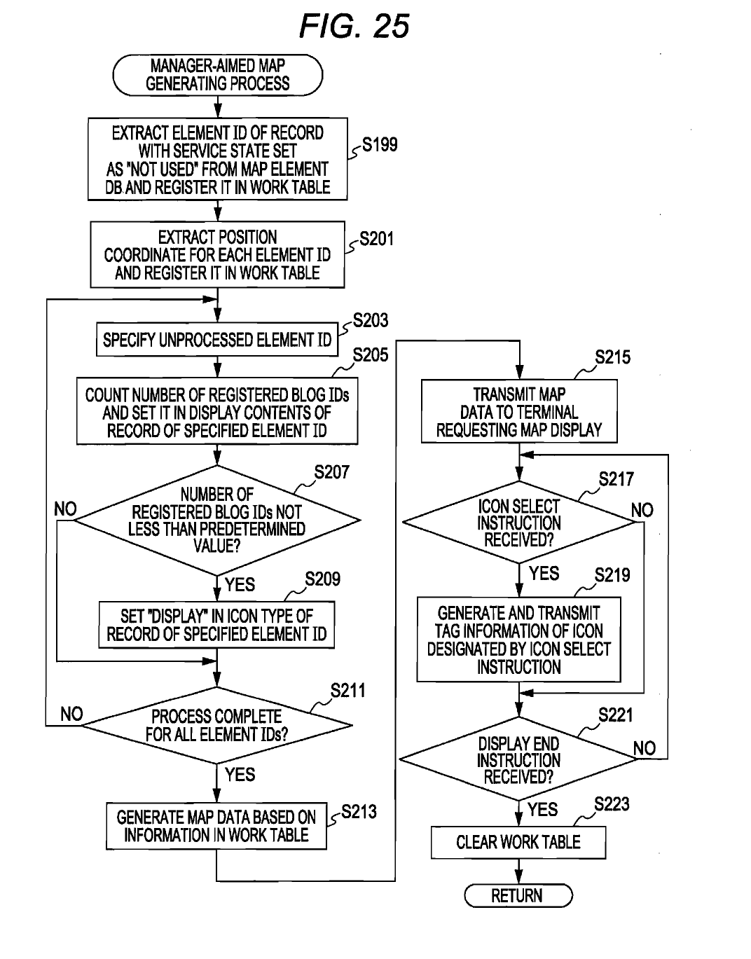

Next, the manager-aimed map generating process executed in S111 shown in FIG. 17 will be explained with reference to FIGS. 25 to 27. First, the map generating unit 723 of the server 72 extracts an element ID of a record with the service usage set as “not used” from the map element DB 76 and registers it in the work table 724 (S199 in FIG. 25). Also, the map generating unit 723 extracts the coordinate from the map element DB 76 for each element ID and registers it in the work table 724 (S201).

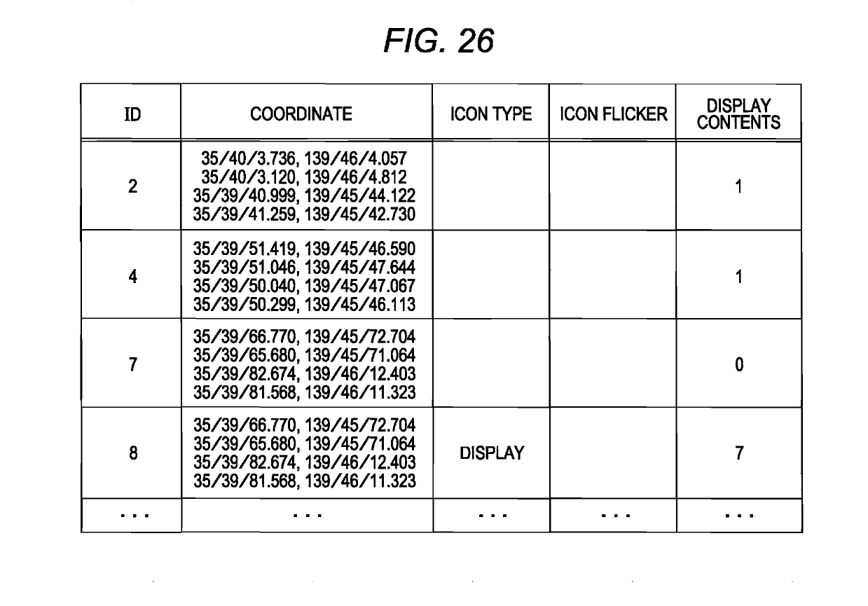

FIG. 26 shows an example of the data stored in the work table 724. In the case of FIG. 26, the ID, the coordinate, the icon type, the icon flicker and the display contents are registered. The “icon type” column has set therein “display” in the case where the mark indicating the map element corresponding to a particular element ID is displayed on the map. In the case where such a mark is not displayed, on the other hand, the “icon type” column remains blank. The display contents are explained later. According to this embodiment, the “icon flicker” column is not used for the manager-aimed map generating process. In the case of FIG. 26, the data is set in the “icon type” and “display contents” columns. As of this timing, however, nothing is set as yet.

Then, the map generating unit 723 specifies an unprocessed element ID in the work table 724 (S203). The map generating unit 723, referring to the record of the element ID in the map element DB 76, counts the number of the registered blog IDs and sets it in the display contents of the record of the specified element ID in the work table 724 (S205). The map generating unit 723 determines whether the number of the counted registered blog IDs is not less than a predetermined value or not (S207). In the case where the counted number of the registered blog IDs is not less than the predetermined value (route to YES in S207), the map generating unit 723 sets “display” in the icon type of the record of the specified element ID in the work table 724 (S209). In the case where the counted number of the registered blog IDs is less than the predetermined value (route to NO in S207), on the other hand, the process skips S209 and proceeds to S211.

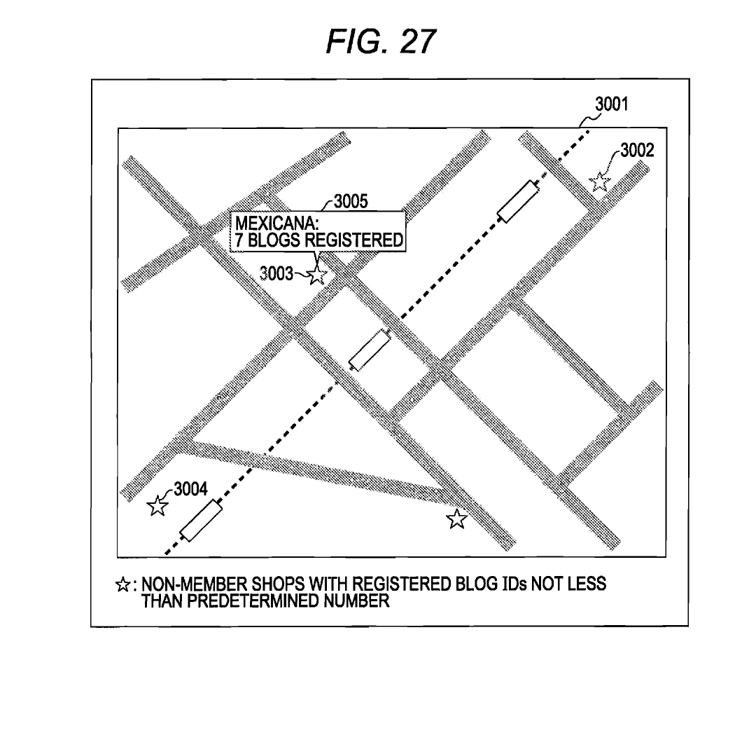

The map generating unit 723 determines whether the process is complete for all the element IDs or not (S211). In the case where the process is not complete for all the element IDs (route to NO in S211), the process returns to S203. Upon completion of the process for all the element IDs (route to YES in S211), on the other hand, the map generating unit 723 reads map data in the display range from the map DB 75 while at the same time generating map data having arranged therein a mark indicating a map element corresponding to the element ID of the record with “display” set in the icon type in the work table 724 (S213). Then, the map generating unit 723 transmits the generated map data to the terminal requesting the map display (i.e. the manager terminal 71) (S215). The manager terminal 71 receives the map data from the server 72 and displays it on the display unit. A screen shown in FIG. 27, for example, is displayed. The map display screen shown in FIG. 27 includes a map display column 3001. Icons 3002 to 3004 are displayed in the map display column 3001.

Also, the map generating unit 723 determines whether the icon selection instruction is received from the manager terminal 71 or not (S217). For example, in the case where any of the icons is clicked by the manager of the blog service system 7 on the map display screen of FIG. 27, the manager terminal 71 transmits an icon selection instruction including identification information of a selected icon to the server 72. Upon receipt of the icon selection instruction (route to YES in S217), the map generating unit 723 generates tag information of the icon designated in the icon selection instruction and transmits it to the manager terminal 71 (S219). The manager terminal 71, upon receipt of the tag information from the server 72, displays a tag on the map display screen of FIG. 7. For example, a tag 3005 (FIG. 27) is displayed. In the case of FIG. 27, an element name “Mexicana” and the number of the registered blog IDs (“seven blogs registered”) are displayed. An address, etc. may also be displayed.

In the case where the icon selection instruction is not received (route to NO in S217), on the other hand, the map generating unit 723 determines whether a display end instruction is received or not (S221). In the case where the display end instruction is not received (route to NO in S221), the process returns to S217. Upon receipt of the display end instruction (route to YES in S221), on the other hand, the map generating unit 723 clears the work table 724 (S223) and the process returns to the first step.

By executing the process as described above, the manager of the blog service system, for example, can grasp the existence of the shops who have not subscribed to the service provided by the blog service system (for example, the presentation of the shop-aimed map) but who are closely watched by the blog users. The manager of the blog service system 7 (for example, the service provider such as an internet service provider) can expect an increased number of subscriptions by urging these shops to newly subscribe to the service.

As described above, according to this embodiment, the attribute information of the blog user in the blog service system can be effectively utilized for marketing. Specifically, according to this embodiment, the shops registered in many blogs can be extracted. Also, according to this embodiment, the blog user simply registers a favorite shop in his/her blog. Each shop, on the other hand, can grasp the registration of the blog and the attribute information of the blog users without any special job for collecting the information and present the information on the moving or closing to the blog users. In other words, the shops can carry out the marketing activities without any extra labor.

Embodiments of the invention have been described above. Nevertheless, the invention is not limited to these embodiments. The function block diagrams described above, for example, are not necessarily in correspondence with the actual programmed modular configuration. Also, the server 72 may be implemented by plural instead of single computer.

Also, the configuration of each table described above is only an example and other configurations may alternatively be employed. Further, each processing flow described above may include the processing steps in a different order as long as the same processing result is obtained. Furthermore, the processes may be executed in parallel.

Further, although an example has been shown above in which the manager-aimed map is presented to the manager of the blog service system 7, information such as the address or means of contact with a shop closely watched by the blog users may be supplied in place of the manager-aimed map.

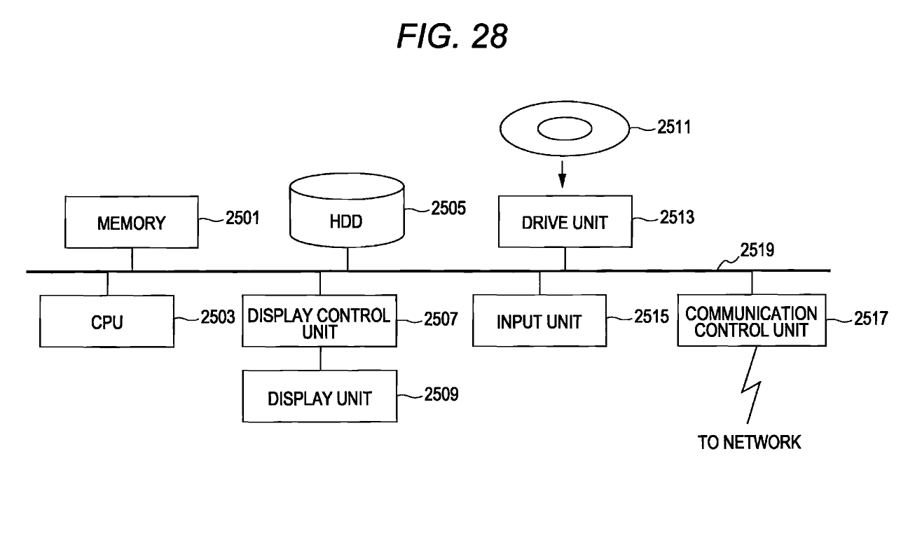

The blog user terminal 3, the shop terminal 5, the manager terminal 71 and the server 72 may be a computer system, as shown in FIG. 28, including a memory 2501 (storage unit), a CPU 2503 (processing unit), a hard disk drive (HDD) 2505, a display control unit 2507 connected to a display unit 2509, a drive unit 215 for a removable disk 2511, an input unit 2515 and a communication control unit 2517 for connection to a network, all of which are connected to each other through a bus 2519. The operating system (OS) and the application program for executing the process according to this embodiment are stored in the HDD 2505, and read from the HDD 2505 to the memory 2501 at the time of execution by the CPU 2503. If required, the CPU 2503 executes the required operation by controlling the display control unit 2507, the communication control unit 2517 and the drive unit 2513. Also, the data being processed is stored in the memory 2501, and if required, in the HDD 2505. According to this embodiment, the application program for executing the aforementioned process is stored in the removable disk 2511, distributed and installed in the HDD 2505 from the drive unit 2513. The application program may alternatively be installed in the HDD 2505 through the network such as the internet and the communication control unit 2517. In this computer system, the various functions described above are realized by systematic collaboration between the hardware such as the CPU 2503 and the memory 2501 on the one hand and the OS and the required application program on the other hand.

Incidentally, a program for executing the aforementioned method by the computer can be generated and stored in a storage medium or a storage unit such as a flexible disk, CD-ROM, magnetooptic disk, semiconductor memory or hard disk. Also, the program may be distributed as a digital signal through a network or the like. The intermediate processing result is temporarily stored in a storage unit such as a main memory. In other words, the embodiments can be implemented in computing hardware (computing apparatus) and/or software, such as (in an unlimiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over a transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. Examples of transmission communication media include a carrier-wave signal, an optical signal, etc.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A marketing support processing method executed by a computer, the method comprising:
specifying a map element corresponding to a shop, upon a map display request by a shop terminal;
referring to a map element database storing information on shops corresponding to each map element and identification information of a registerer blog including the map element, and specifying the identification information of the registerer blog corresponding to the specified map element;
extracting registered address information of a blog user of each specified registerer blog from a user master database storing the registered address information of the blog user, and storing the registered address information of the blog user in a storage unit in correspondence with the identification information of the registerer blog; and
generating shop-aimed map data having a mark indicating each of the registerer blogs in accordance with the registered address information of the blog user stored in the storage unit, and transmitting the map data to the shop terminal.

2. The marketing support processing method according to claim 1, further comprising:
when an instruction of selecting the mark indicating the registerer blog is received from the shop terminal, generating tag information including the registered address information of the blog user of the registerer blog designated by the received selection instruction, and transmitting the tag information to the shop terminal.

3. The marketing support processing method according to claim 1, further comprising:
storing in a blog management database identification information of a map element registered in a map of the blog user;
upon receipt of the map display request from a blog user terminal, extracting the identification information of the map element registered by the blog user from the blog management database and storing the map element identification information in the storage unit; and
generating blog-user aimed map data having arranged therein a mark indicating a shop corresponding to the map element identification information stored in the storage unit in accordance with the information of the shop stored in the map element database and transmitting the map data to the blog user terminal.

4. The marketing support processing method according to claim 1, wherein the map element database has further stored therein a state of subscription to a predetermined blog service provided for each map element,
the method further comprising:
upon receipt of the map display request from a blog manager terminal, referring to the map element database and specifying first non-member shops having not subscribed to the predetermined service;
acquiring a number of registerer blogs corresponding to the first non-member shops from the map element database;
specifying second non-member shops included in the first non-member shops and having the registerer blogs in a number not less than a predetermined value; and
generating blog manager-aimed map data having arranged therein marks indicating the second non-member shops in accordance with the information on the shop stored in the map element database and transmitting the map data to the manager terminal.

5. The marketing support processing method according to claim 1, wherein the shop-aimed map generating further includes when the registerer blog meets predetermined conditions, generating the map data highlighting a mark indicating the registerer blog.

6. The marketing support processing method according to claim 5,
wherein the blog management database further stores blog user identification information for each blog, and one or more of a number of comments or a number of trackbacks corresponding to the blogs,
wherein the shop-aimed map data is generated based upon the blog management database, and
wherein the predetermined conditions include a condition that the number of comments corresponding to the registerer blog is not less than a predetermined number, a condition that the number of trackbacks corresponding to the registerer blog is not less than a second predetermined number, or a condition that a sum of the number of comments and the number of trackbacks corresponding to the registerer blog is not less than a third predetermined number, or any combinations thereof.

7. The marketing support processing method according to claim 2, wherein
the user master database further stores attribute information of the blog user, and
the tag information generating further comprises containing in the tag information the attribute information of the blog user of the registerer blog designated by the selection instruction.

8. The marketing support processing method according to claim 3, wherein
the map element database further stores information on a moving or a closing of a shop, and
the blog user-aimed map generating further comprises when the map element is stored in correspondence with the information on the moving or closing of the shop, generating the map data highlighting a mark indicating the shop corresponding to the map element.

9. The marketing support processing method according to claim 4,
wherein the manager-aimed map generating further comprises generating the map data displaying the number of the registerer blogs.

10. A marketing support processing system comprising:
first specifying means for, upon receipt of a map display request from a shop terminal, specifying a map element corresponding to a shop;
second specifying means for, based on identification information for the map element specified by the first specifying means, referring to a map element database for storing information on shops corresponding to each map element and identification information of a registerer blog including the map element and specifying the identification information of the registerer blog corresponding to the map element;
means for extracting registered address information of a blog user of each registerer blog specified by the second specifying means from a user master database for storing the registered address information of the blog user, and storing the registered address information of the blog user in a storage unit in correspondence with the identification information of the registerer blog; and
shop-aimed map generating means for generating map data having arranged therein a mark indicating each of the registerer blogs in accordance with the registered address information of the blog user stored in the storage unit, and transmitting the map data to the shop terminal.

11. A computer readable recording medium recording a marketing support processing program for controlling a computer to execute operations comprising:
upon receipt of a map display request from a shop terminal, specifying a map element corresponding to a shop;
based on identification information for the specified map element, referring to a map element database storing information on shops corresponding to each map element and identification information of a registerer blog including the map element and specifying the identification information of the registerer blog corresponding to the map element;
extracting registered address information of the blog user of each specified registerer blog from a user master database storing the registered address information of the blog user, and storing the registered address information of the blog user in a storage unit in correspondence with the identification information of the registerer blog; and
generating shop-aimed map data having arranged therein a mark indicating each of the registerer blogs in accordance with the registered address information of the blog user stored in the storage unit, and transmitting the map data to the shop terminal.

12. A marketing apparatus, comprising:
a map element database storing information on a shop corresponding to a map element of a map and identification information of a registerer blog including the map element;
a user master database storing registered address information of a blog user; and
a controller
upon receipt of a map display request from a shop terminal, a user terminal, or a manager terminal, or any combinations thereof, specifying the map element corresponding to the shop,
based on the specified map element, referring to the map element database and specifying the identification information of the registerer blog corresponding to the map element,
extracting, from the user master database, registered address information of the blog user of the specified registerer blog,
storing the registered address information of the blog user in correspondence with the identification information of the registerer blog, and
providing shop-aimed, user-aimed, or manager-aimed, or any combinations thereof, map data indicating information related to the registerer blog, according to the registered address information of the blog user.
